(19) United States
(12) Patent Application Publication
(10) Pub. No.: US 2008/0109409 A1
(43) Pub. Date: May 8, 2008

(54) Brokering keywords in radio broadcasts

(75) Inventor: Charles M. Hengel, Woodland, MN (US)

Correspondence Address: SCHWEGMAN, LUNDBERG & WOESSNER, P.A., P.O. BOX 2938, MINNEAPOLIS, MN, 55402, US

(73) Assignee: MA Capital LLLP

(21) Appl. No.: 11/800,477

(22) Filed: May 3, 2007

Related U.S. Application Data
(60) Provisional application No. 60/857,618, filed on Nov. 8, 2006.

(51) Int. Cl. G06F 17/30; G06Q 30/00

(52) U.S. Cl. 707/3; 705/14; 707/104.1

(57) ABSTRACT

In one embodiment, a method is illustrated as comprising receiving a selected advertising keyword, wherein the selected advertising keyword is associated with an advertisement transmitted across a network, monetizing the selected advertising keyword, and storing the selected advertising keyword in a database. This method may include monetizing based upon at least one of a selected keyword activity, or a selected keyword ranking. Further, the network may include at least one of a radio network, a television network, a cable network, or an internet network.

### CROSS REFERENCE TO RELATED APPLICATIONS

This is a non-provisional patent application related to U.S. Provisional Patent Application Nos. 60/744,325, titled “SYSTEM FOR AND METHOD OF REWARDING SELLERS OR SUPPLIERS OF GOODS OR SERVICES” and 60/857,618 titled “SYSTEM AND METHOD FOR ORGANIZING AND DISTRIBUTING AUDIO INFORMATION”. Further, it is related to United States Non-Provisional patent application Nos. 11/469,719 titled “SYSTEM FOR AND METHOD OF VISUAL REPRESENTATION AND REVIEW OF MEDIA FILES”, 11/469,731 titled “DIRECT RESPONSE SYSTEM FOR AND METHOD OF SELLING PRODUCTS”, 11/469,737 titled “SYSTEM FOR AND METHOD OF STREAMLINING COMMUNICATIONS TO MEDIA STATIONS”, and 11/469,743 titled “ADVERTISING PLACEMENT SYSTEM AND METHOD”, XX/XXX,XXX titled “SYSTEM AND METHOD FOR GENERATING ADVERTISEMENTS FOR USE IN BROADCAST MEDIA” and, XX/XXX,XXX titled “USING INTERNET ADVERTISING AS A TEST BED FOR RADIO ADVERTISEMENTS” all of which (e.g., both the provisional and non-provisional patent applications) are incorporated by reference in their entirety.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be illustrated below and in the drawings that form a part of this document: Copyright © 2007, Marketing Architects, Incorporated. All Rights Reserved.

### TECHNICAL FIELD

The present application relates generally to the technical field of algorithms and programming and, in one specific example, to generate search results based upon advertising.

### BACKGROUND

Today advertisers often conduct advertising campaigns that seek to promote certain goods and services across multiple advertising mediums. For example, some advertising campaigns utilize the radio waves in combination with television and even the internet. In popular culture, such campaigns may be referred to as a media blitz of advertising where multiple forms of media are used at once to convey the same or similar advertising message.

### BRIEF DESCRIPTION OF THE DRAWINGS

Some embodiments are illustrated by way of example and not limitation in the figures of the accompanying drawings in which:

FIG. 1 is a diagram of a system including a broadcast station that broadcasts advertisements over a network, according to an example embodiment.

FIG. 2 is a diagram of a system illustrating many of the devices utilized by this system to both generate an advertisement and conduct search queries based upon this advertisement, according to an example embodiment.

FIG. 3 is a diagram of an system illustrating the generation of an advertisement and the associating of geographical information with this advertisement based upon, for example, an IP address, according to an example embodiment.

FIG. 4 is a diagram of an system illustrating the use of a user keyword advertising interface to select certain advertising, according to an example embodiment.

FIG. 5 is a diagram of a system illustrating the setting up of an account on a system, wherein selected advertising keywords may be used to provide search results, according to an example embodiment.

FIG. 6 is a diagram of a data packet, according to an example embodiment.

FIG. 7 is an interface illustrating a keyword advertising interface, according to an example embodiment.

FIG. 8 is an interface illustrating a search query and results interface, according to an example embodiment.

FIG. 9 is an interface illustrating an account setup interface, according to an example embodiment.

FIG. 10 is a block diagram illustrating the various modules that may reside on a search application server, according to an example embodiment.

FIG. 11 is a block diagram illustrating the various modules that may reside on a search application server applying various metrics to evaluate an advertisement, according to an example embodiment.

FIG. 12 is a block diagram illustrating the various modules that may reside on a search application server seeking to monetize various selected advertising keywords, according to an example embodiment.

FIG. 13 is a dual stream flowchart illustrating a method with a first stream titled “Generating and Storing Selected Advertising Keywords” and a second stream titled “Retrieving Search Results Based Upon Selected Advertising Keywords”, according to an example embodiment.

FIG. 14 is a flowchart illustrating a method used to implement an operation used to generate an advertisement, according to an example embodiment.

FIG. 15 is a flowchart illustrating a method used to implement an operation to allow for the selecting of certain advertising keywords, according to an example embodiment.

FIG. 16 is a flowchart illustrating a method used to implement an operation that receives the select advertising keywords, according to an example embodiment.

FIG. 17 is a flowchart illustrating a method used to implement an operation that receives an advertisement, according to an example embodiment.

FIG. 18 is a flowchart illustrating a method to implement an operation to store selected advertising keywords into a database, according to an example embodiment.

FIG. 19 is a flowchart illustrating a method used to implement an operation to activate these advertising keywords, according to an example embodiment.

FIG. 20 is a flowchart illustrating a method used to implement an operation that receives a search query from a user that contains select advertising keywords, according to an example embodiment.

FIG. 21 is a flowchart illustrating a method used to implement an operation that generates a search query based, in part, upon a second advertising keyword, according to an example embodiment.

FIG. 22 is a flowchart illustrating a method used to implement an operation to transmit a search query to a search engine, according to an example embodiment.

FIG. 23 is a flowchart illustrating a method used to implement an operation to generate an advertisement, according to an example embodiment.

FIG. 24 is a flowchart illustrating a method used to implement a sorting operation, according to an example embodiment.

FIG. 25 is a flow chart illustrating a method used to execute an operation to sort keywords based upon metrics, according to an example embodiment.

FIG. 26 is a Relational Data Schema (RDS) illustrating various database tables, according to an example embodiment.

FIG. 27 shows a diagrammatic representation of a machine in the example form of a computer system.

### DETAILED DESCRIPTION

In the following description, for purposes of explanation, numerous specific details are set forth in order to provide a thorough understanding of example embodiments. It may be evident, however, to one skilled in the art that the present invention may be practiced without these specific details.

According to an embodiment, a system and method for coordinating advertising efforts conducted over various mediums (e.g., radio, TV, web cast, pod cast, or other suitable medium) with internet search engines and results arising from the implementation of such engines are illustrated. In one embodiment, an advertiser may select certain keywords contained in an advertisement (e.g., name of the product, name of the seller), and pay to have these keywords given sort priority during the course of utilizing an internet search engine to retrieve search results relating to the keywords. Moreover, a specific geographical location may be paired with the search query based upon the location of the party making the query (e.g., the searcher), and/or the location of the party presenting the advertisement (e.g., the advertiser). The location may be determined on the searcher side by determining and using the Internet Protocol (IP) address of the searcher, or the actual geographical terms used in the search query (e.g., “widgets and Minneapolis”). The location on the advertiser side may be determined by using the IP address of the advertiser (where available), or by analyzing the advertisement for geographical terms or phrases. Once this pairing takes place, then search results relating to the advertised company and their products may be sorted so as to give them priority.

Other features may be apparent from the accompanying drawings and from the detailed description that follows.

Given the variety of advertising mediums available to advertisers, the ability to coordinate these various advertising activities becomes tougher and tougher. For example, advertising over radio waves is distinct from advertising over the internet both in terms of the actual physical medium (e.g., sound versus text), and the method by which one may advertise. Given this distinctive nature, customers tend to seize upon certain keywords associated with a seller as an identifier for the seller (e.g., widgets as a product and Acme as a seller). More detailed information may be lost (e.g., the actual physical location of a seller). One way to coordinate these various advertising mediums is to allow potential customers to use the information from one medium to facilitate the obtaining of information regarding a seller in another medium. For example, a potential customer may want to use the internet to find out (e.g., search for) information regarding sellers of widgets manufactured by Acme corporation in their geographical location. Through allowing sellers in particular geographical locations to purchase keywords used by search engines, and giving search result prior to these sellers on the basis of their geographical location relative to the potential customer (e.g., searcher), a form of cross marketing is created. More to the point, in cases where a potential customer located in, for example, Minneapolis, wants to learn about more widgets manufactured by Acme, after hearing a Minneapolis radio advertisement for these widgets, the customer may conduct a web search for such information. By allowing sellers of the widgets to purchase keywords related to widgets and Acme, and by pairing the sellers geographical location information (e.g., derived from an IP address) with that of the potential customer (e.g., derived from an IP address), search results may be tailored.

In some embodiments a keyword may be purchased for some finite period of time (e.g., 1 day, 15 minutes), and a finite number of searches for a keyword may be purchased (e.g., 10,000 search hits). The keyword purchase may be localized, such that only potential customers from a related geographic region would receive, for example, the Minneapolis Mortgage link/advertisement or search result. The advertisement may be based upon a radio advertisement played at a corresponding time period, and one or more of the words in this advertisement (e.g., keywords) are “reserved” for the advertiser, such that when a potential customer submits a search using one of the keywords, the advertiser's website or other presence is made available (e.g., search results, banner ad, website link, interactive advertising content, etc).

Some embodiments may include the use the various metrics (e.g., broadcast metrics) to drive keyword sales and the monetizing of these keywords. These metrics may include the audience size that hears, views, or otherwise comes into contact with an advertisement containing a keyword. Based on these metrics, a keyword may be more or less expensive in terms of the cost of paying for it (e.g., the placement fee) to be ranked higher in a search result generated by a search engine. Further types of monetizing may include attaching a higher cost to keywords related to advertisements generated as part of a time offered broadcast advertisement. A time offered broadcast may be, for example, an infomercial or other program devoted to the selling of product, or a time during which a buyer might receive a discount on a product price, if the buyer purchases the product within the time period. Additionally, monetizing may include attaching a higher cost to keywords associated with advertisements for products that are related to a primary product and the advertisements and keywords associated therewith. For example, if a search query seeking information related to “Acme” and “widgets”, then other keywords associated with other advertised products offered by Acme may also be retrieved as part of a search result. These other advertised products, and the keywords associated with these advertisements, may only retrieve a higher ranking in a search result where an advertiser pays for this higher ranking, even though the initial search query is for an unrelated product.

Example embodiments may include the party operating a search engine as a party who monetizes and sells the keywords (e.g., the party who sets the placement fee), while, in some embodiments, a party unrelated (e.g., a keyword broker) to the search engine may sell or monetize the keywords. The party operating the search engine and the key word broken may even be one and the same. A keyword broker may, for example, sell keywords in a market for keywords where market participants (e.g., buyers of keywords) are willing to bid competitively on keywords to be used in advertisements to be subsequently used in search queries on the internet. This keyword broker may even sell keywords outright, without the use of a bidding process.

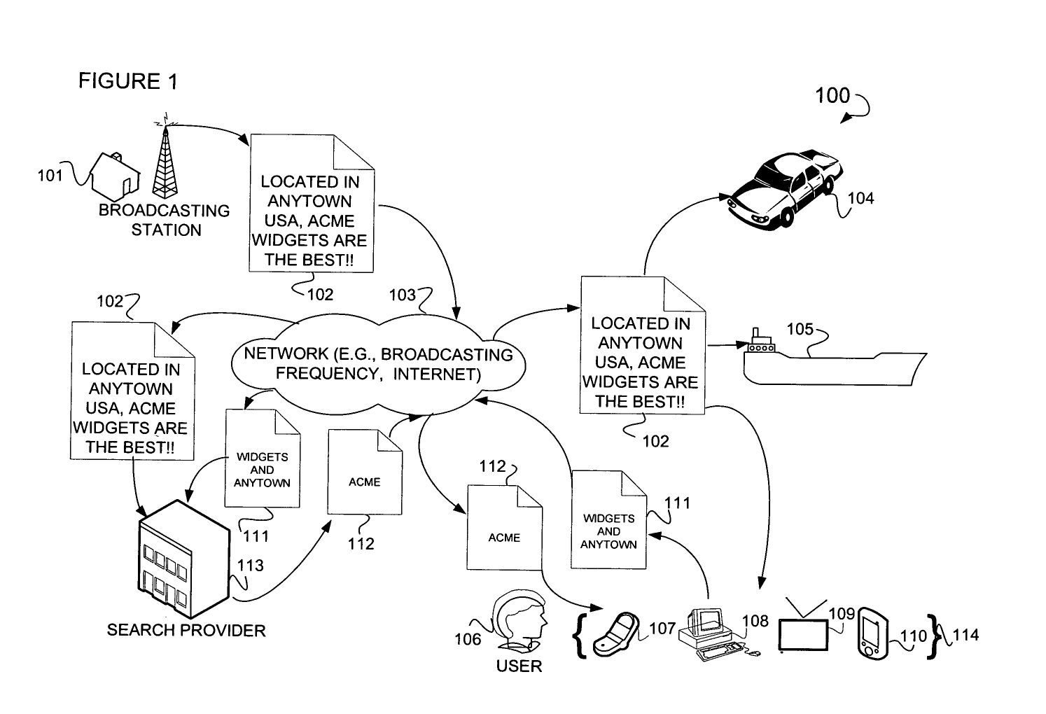

FIG. 1 is a diagram of an example system 100. Illustrated is a broadcasting station 101 that broadcasts an advertisement 102 over a network 103. This network 103 may be, for example, a variety of stations connected by some regulated broadcasting frequency such as a radio, television or satellite. In some embodiments, this network maybe an internet or other type of suitable network. This advertisement 102 is broadcast to a variety of different types of devices that may reside in a variety of different types of vehicles. For example, the advertisement 102 may be broadcast across the network 103 to a car or automobile 104. In other cases, the advertisement is broadcast across the network 103 to a ship 105. In still other cases, this advertisement 102 is broadcast across the network 103 to any one of a number of devices 114 including a cell phone 107, a computer system 108, a television 109, a Personnel Digital Assistant (PDA) 110, and/or some other suitable device. In some cases, one or more of these devices 114 is utilized by a user 106 to review, hear, or otherwise receive, the advertisement 102.

In some cases, the user 106 may desire to learn more about the information conveyed by the advertisement 102. For example, a user 106, utilizing one of the devices 114, may conduct a search utilizing the network 103 in the form of, for example, an internet. This search, such as search 111, may be for widgets and the relationship between widgets and some particular geographical location here represented as “Anytown”. This search 111 may be sent across the network 103 to a search provider 113. Some well known search providers (e.g., search engine providers) include GOOGLE™, YAHOO™, MSNBC™, DOG PILE™, or some other suitable search provider. Once this search 111 is conducted, the search provider receiving the search 111 across the network 103 may return a name of a company as a search result 112. This search result 112 may be transmitted across the network 103 for review by the user 106 utilizing one of the devices 114. In some cases, another user residing in, for example, automobile 104 or residing on, for example, the ship 105, may also be able to conduct a search, such as search 111. The search result 112 reflects the name of the company associated with the initial advertisement 102. As will be more fully discussed below, this search result 112 may be predicated in part upon the geographical location of the user 106 relative to the geographical location of the particular advertiser authoring the advertisement 102 or, for example, the geographical location of the particular broadcast station (e.g., broadcast station 101).

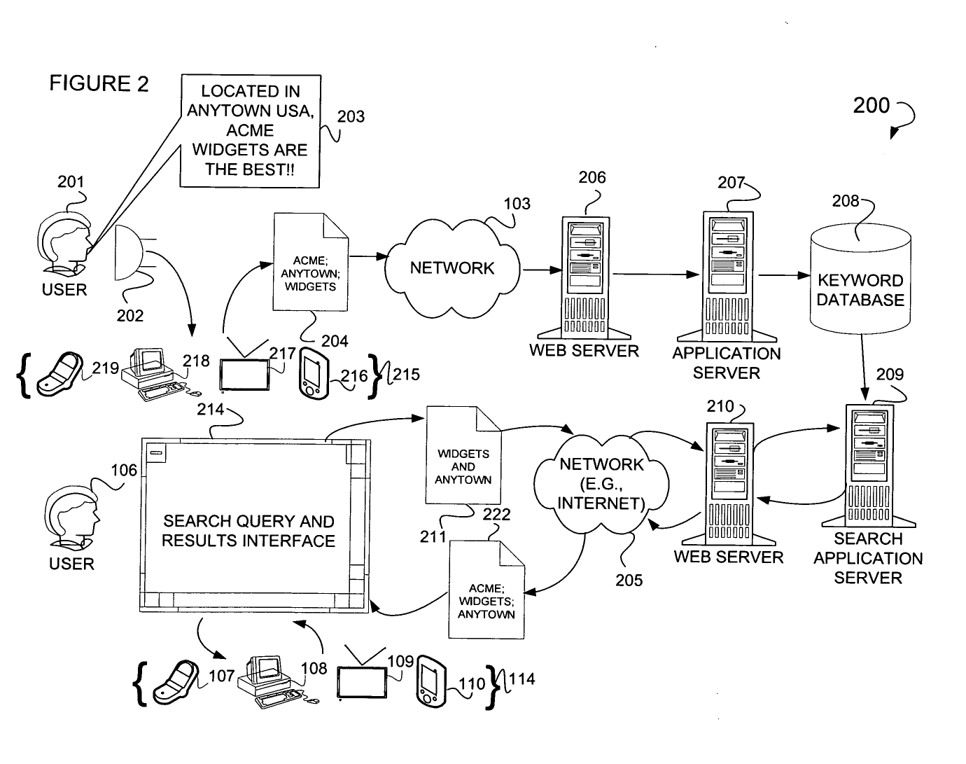

FIG. 2 is a diagram of an example system 200 illustrating many of the devices utilized to generate an advertisement and conduct search queries based upon this advertisement. Illustrated is a user 201 who, utilizing a microphone 202, generates an advertisement 203. This microphone 202 may reside on, or otherwise be associated with, any one of a number of devices 215. These devices 215 include a PDA 216, a television 217, a computer system 218, a cell phone 219 or some other suitable device. These devices 215 may be utilized as a part of a larger broadcasting station 101. Once the advertisement 203 is generated, keywords associated with this advertisement, known as selected advertising keywords, may be parsed out of the advertisement 203 or otherwise selected as keywords 204 and transmitted over a network 103 to a web server 206 and ultimately to an application server 207. When received by the application server 207, these selected advertising keywords may be stored into a keyword database 208. Once these selected advertising keywords 204 are stored and sorted in the keyword database 208, the advertising keywords 204 may be used to facilitate a search for information relating to the party with respect to which the advertisement 203 pertains (e.g., the advertiser). For example, a user 106 utilizing an interface 214, that may reside on any one of the previously illustrated devices 114, may conduct a search 211 for widgets in “Anytown”. This search is then transmitted across a network such as an network 205 to a web server 210 and ultimately to a search application server 209. Once the search application server 209 receives the search 211, the search application server 209 may access the keyword database 208 so as to obtain the name of a particular company that sells widgets in “Anytown”. Once this search 211 is conducted, the results 222 (e.g., search results) are passed in some cases back through the web server 210 and across network 205 to the user 106 for viewing via the search query and results interface 214. In other cases, the search applications server 209 may transmit the search results directly across the network 205 without utilizing the web server 210 to the user 106 for viewing via the search query and result interface 214.

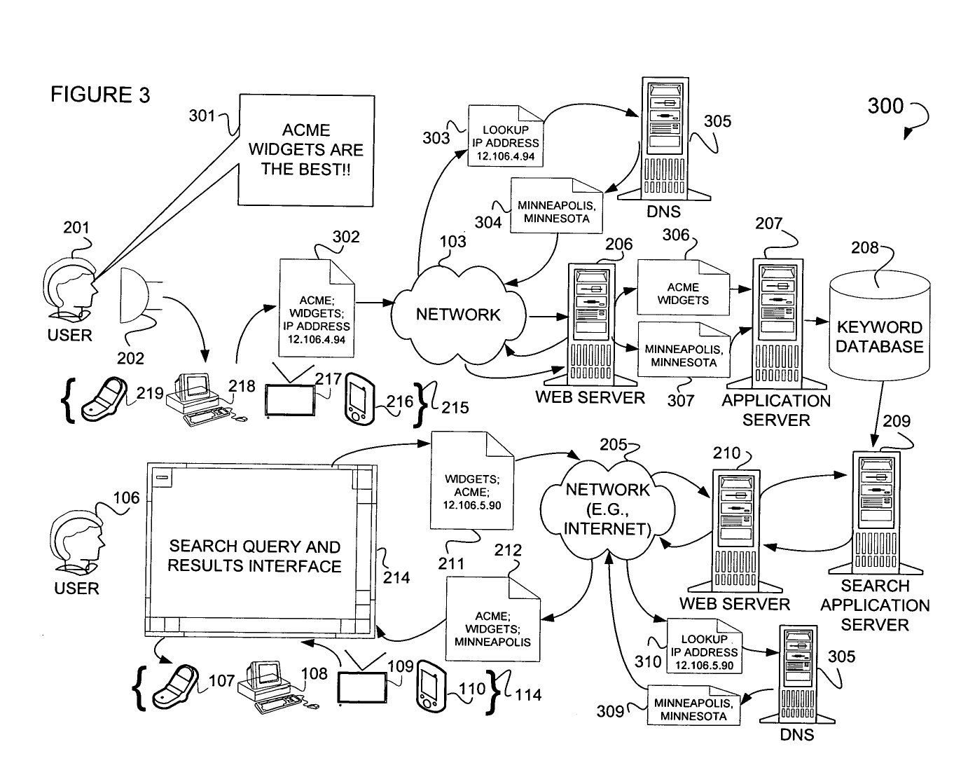

FIG. 3 is a diagram of an example system 300 illustrating the generation of an advertisement and associating of geographical information with this advertisement based upon, for example, a IP address. Illustrated is a user 201 who, utilizing the previously illustrated microphone 202, generates an advertisement 301. Once generated, or prior to be being generated, certain selected advertising keywords are taken from this advertisement 301, associated with an IP address, and transmitted across the network 103. In some cases, these selected advertising keywords and IP address are transmitted across a network 103 as, for example, a data packet 302. This data packet may be formatted utilizing a Transmission Control Protocol/Internet Protocol (TCP/IP), User Datagram Protocol/Internet Protocol (UDP/IP), or some other protocol well known in the art. Once the data packet 302 is transmitted across the network 103, it is received by a web server 206. This web server 206 may query a Domain Name Server (DNS) 305 utilizing a query request 303. This query request 303 may be sent across the previously illustrated network 103. Once the query request 303 is received by the DNS 305, a response 304 is sent back across the network 103 to the web server 206. This response 304 may contain geographical information based upon the IP address provided by the DNS query 303. Here a response 304 contains information to the effect that Minneapolis, Minn. is the geographical location associated with the IP address provided in the data packet 302. Once the web server 206 receives the query results from the DNS 305, it transmits these results as a data packet 307 along with a second data packet 306 that contains the selected advertisement keywords. In some embodiments, this data packet 307 may contain the geographical location associated with the IP address along with the IP address itself and even a Uniform Resource Locator (URL) value associated with the IP address. These two packets (e.g., 306 and 307) are sent to the previously illustrated application server 207 which ultimately stores these packets (e.g., 306 and 307) into a keyword database 208.

In some cases, a user 106 utilizing a search query and result interface 214 may conduct a search for a particular good or service for sale in his or her geographical region. For example, utilizing the search query and result interface 214, the user 106 may send a search 211 across a network 205 to a web server 210. Once this search query 211 is received by the web server 210, the web server 210 may conduct a DNS lookup utilizing a DNS 305. As illustrated, a DNS lookup 310 contains the IP address associated with one of the devices 114 utilized by the user 106. Once the DNS lookup 310 is received by the DNS 305, a DNS search result 309 is returned which, in this case, reflects the fact that Minneapolis, Minn. is the geographical location of the one or more devices 114 utilized by the user 106. This DNS search result 309 is then sent from the DNS 305 back across the network 205 to the web server 210 and ultimately to the search application server 209. In some cases, the search application server 209 may utilize this geographical location relating to the device utilized by the user 106 to perform a lookup of selected keywords contained in the keyword database 208. By performing this lookup, a search result 212 may be transmitted by the search application server 209 to the web server 210 which may then, in turn, transmit this search result 212 back across the network 205 ultimately for viewing by the user 106 on the search query and result interface 214. In some cases, the search application server 209 utilizes the DNS search result 309 to determine the name of a company selling the good or service for which the user 106 has conducted the search (e.g., 211). For example, here user 106 conducts a search for “widgets” and “Acme”, and during the course of conducting the search conveys his or her geographical location to the search application 209. The search application server 209 may then use its geographical information receiver from, for example, an advertiser to find a company named “Acme” that sells “widgets” near the user 106's geographical location (e.g., Minneapolis, Minn.).

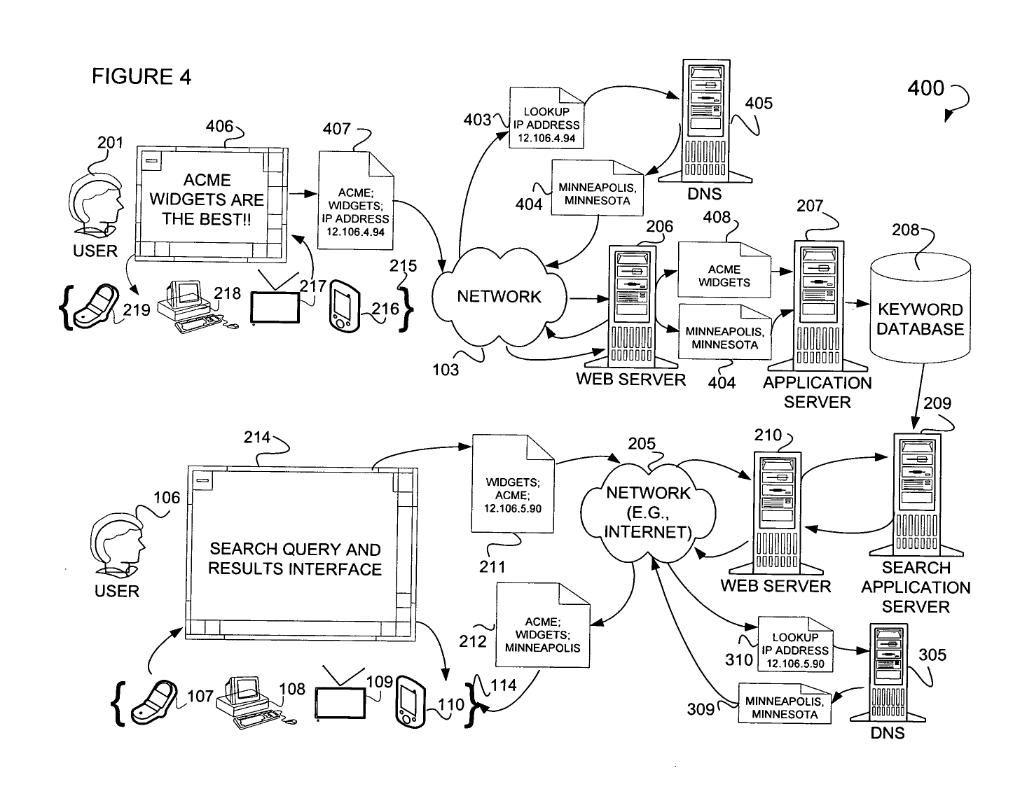

FIG. 4 is a diagram of an example system 400 illustrating the use of a user keyword advertising interface 406 to select certain advertising keywords for the purpose of giving priority to these keywords in a keyword database. Illustrated is a user 201 who, utilizing a user keyword advertising interface 406, may generate an advertisement and/or select certain selected keywords relating to this advertisement. Here the user 201, utilizing the user keyword advertising interface 406, selects certain advertising keywords such as “Acme” and “widgets”. This user keyword advertising interface 406 resides, in some cases, on any number of devices 215. Once these selected advertising keywords are selected, they are sent as a data packet 407 across a network 103 to a web server 206 and ultimately to an application server 207. While being sent across the network 103, this data packet 407 may be parsed by the web server 206 for the purposes of determining the IP address associated with the device or devices 215 utilized by the user 201. The selection of advertising keywords, as previously illustrated, may be performed by utilizing, for example, a DNS 405 wherein the web server 206 may send the DNS 405 a DNS query 403 containing the IP address of a user 201 and/or the device utilized by user 201. In response to the DNS query 403, the DNS 405 may provide the geographical location corresponding to the IP address containing the DNS query 403 represented by DNS search result 404 (e.g., Minneapolis, Minn.). This DNS search result 404 may then be transmitted across network 103 to the web server 206. When received by the web server 206, the DNS search result 404 may be associated with certain selected keywords represented here as a data packet 408 containing the actual geographical location of the IP address (e.g., Minneapolis, Minn.), IP address, or URL value associated with the device utilized by the user 201. This data packet 408 and 409 may be sent to an application server 207 and ultimately stored into the keyword database 208. As previously illustrated, a user 106 may then utilize a search query and search interface 214 to make certain search queries utilizing a network 205 regarding a particular good or service sold by that particular company.

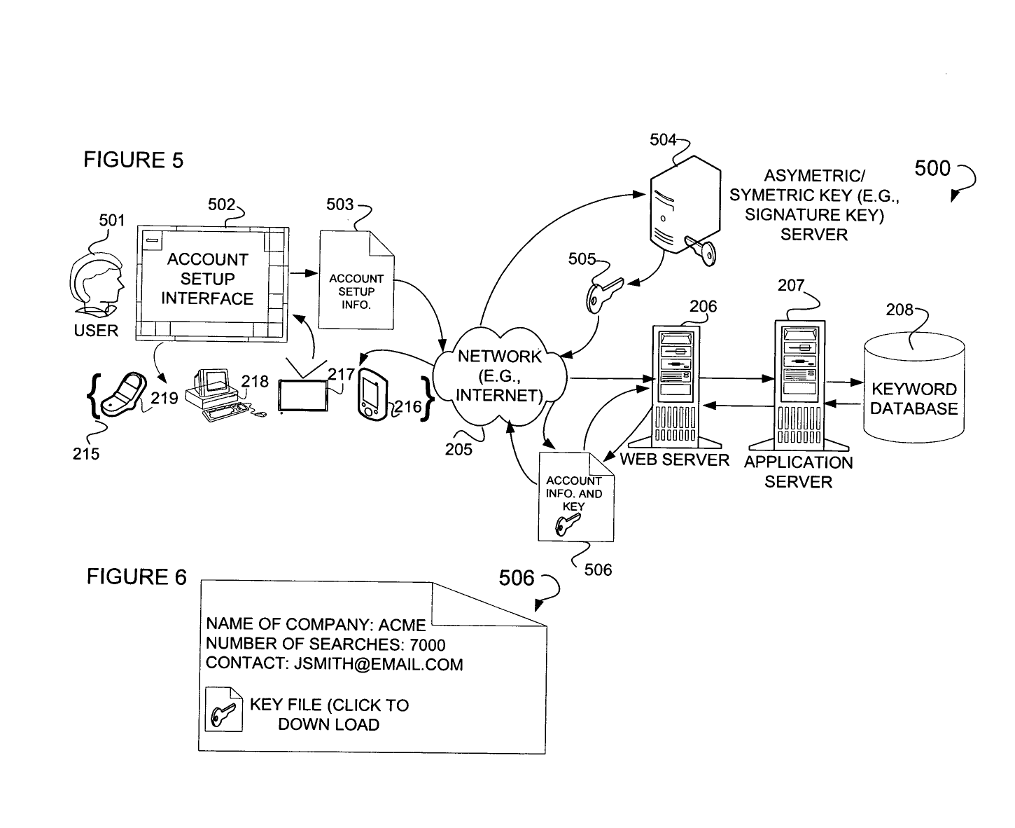

FIG. 5 is a diagram of an example system 500 illustrating the setting up of an account on a system such as system 200, 300, or 400 wherein selected advertising keywords may be used to provide search results. Illustrated is a user 501 who may be, for example, some type of individual associated with a seller of goods or services. This individual may be, for example, a marketing or sales professional or some other suitable representative. This user 501, utilizing an account setup interface 502, may setup an account with one of the previously illustrated systems. This account setup interface 502 may reside on any one of the devices 215 previously illustrated. For example, a user 501 utilizing the account setup interface 502 may generate accounts setup information 503 that is transmitted across a network 205 to a web server 206 and ultimately to an application server 207. In response to the account setup information 503, the web server 206 may request some type of symmetric, asymmetric or highbred encryption based key from, for example, a key server 504. Once this request is made, one of these various types of keys (e.g., symmetric, asymmetric or highbred crypto key) are transmitted back across the network 205 as a key 505 to the web server 206. Once received by the web server 206, the web server 206 may generate an account information data package 506 that may be transmitted across the network 205 back to the user 501. In some cases, this account data packet 506 may be in the form of an e-mail or other suitable way to provide account information to the user 501.

FIG. 6 is a diagram of an example data packet 506. Illustrated is the information that may appear in such a data packet 506 including the name of the company setting up an account. Here an account is set up by “Acme”, and the number of searches that Acme has initially paid for is 7000. Contact information is provided in the form of an email address for J. Smith (e.g., jsmith@email.com). Also provided in this data packet 506 may be key information such as a key file. In some cases, this key may be used as a digital signature to authenticate the identity of the person sending or generating selected keyword information such as keyword information 204 or 302. This key may be used to uniquely identify the company setting up an account with the system.

### A Three-Tier Architecture

In some embodiments, one implementation may be as a distributed or non-distributed software application designed under a three-tier software architecture paradigm, whereby the various modules or operation written in computer code that make up the one implementation can be categorized as belonging to one or more of these tiers. A three-tier architecture is well known in the art.

The first tier is an Interface level that is relatively free of application processing. The second tier is a Logic level that performs processing in the form of logical/mathematical manipulations (Logical Manipulations) of data inputted through the Interface level, and communicates the results of these Logical manipulations with the Interface and/or backend or Storage level. Some example embodiments may include these Logical Manipulations relating to certain business rules or tasks that govern the application as a whole. These logical manipulations and associated business rules are used to associate advertising keywords with search queries based upon the geographical location, IP address and/or URL of the advertiser and the party conducting the search query. The third tier or Storage level is a persistent storage medium, or some example embodiments may include non-persistent storage medium. One or more of these tiers may be collapsed into one another, resulting in a two-tier architecture or a one-tier architecture. For example, the Interface and Logic levels may be consolidated or the Logic and Storage level may be consolidated, as in the case of an application with an embedded database.

This three-tier architecture may be implemented using one technology, or as will be discussed below, a variety of technologies. These technologies may include one or more object-oriented programming languages such as, for example, JAVA™, C++, DELPHI™, C#™, or the like. Additionally, structured programming languages such as, for example, C, may also be used. Moreover, scripting languages such as, for example, Perl, Python, PHP, JAVASCRIPT™ or VBSCRIPT™ may also be used.

This three-tier architecture, and the technologies through which it is implemented can be implemented in two or more computers organized in a server-client relationship, as is well known in the art, such that an Interface level resides on a client computer, whereas a Logic level resides on the application server (see below) and the Storage level resides on a database server (see below). As will be discussed more fully below, in such a relationship these three tiers can be implemented as various software components that communicate via distributed programming protocols. Some example embodiments may include these three tiers being implemented in a peer-to-peer configuration, with centralized or decentralized file and data sharing, or some other suitable file sharing paradigm, such that all three tiers reside on one or more computers and each computer retrieves files and data from one another. Peer to peer configurations are well known in the art.

### An Interface Level

An example embodiment may use a client-based browser application, whereas other embodiments may be implemented via a command-line interface. Some example embodiments of a client based browser application may include an Application Programming Interface (API) implemented to allow one application to communicate with another. Some well-known client-based browser applications include NETSCAPE™, INTERNET EXPLORER™, MOZILLA FIREFOX™, OPERA™, or some other suitable browser application. Common to these browser applications is the ability to utilize a Hyper-Text Transfer Protocol (HTTP) or Secured Hyper-Text Transfer Protocol (HTTPS) to get, upload (e.g., PUT) or delete web pages and interpret these web pages which are written in a Hyper Text Markup Language (HTML) and/or an eXtensible Markup Language (XML). HTTP and HTTPS are well known in the art, as are HTML and XML. HTTP and HTTPS are used in conjunction with a Transmission Control Protocol/Internet Protocol (TCP/IP) protocol as illustrated in the Open Systems Interconnection Reference Model (OSI) model, or the TCP protocol stack model, both of which are well known in the art. The practical purpose of the client-based browser application is to enable a user to interact with the application through the display of plain text, and/or interactive, dynamic functionality in the form of buttons, text boxes, scroll down bars or other objects, and widgets contained on one or more web pages constructed using the aforementioned HTML and/or XML.

Web pages are typically static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages is a product of the use of the other technologies in combination with HTML and/or XML.

Some example embodiments may include using Java Server Page (JSP™), or Active Server Pages (ASP™ or ASP.NET™) (collectively server pages) to provide a user with dynamic web pages or content via their web browser. Additional technology may be implemented in the form of an additional program (e.g., routine) written in another programming language that is embedded into the HTML and/or XML code, allowing for web pages to become dynamic. Some of these additional technologies include, for example, embedded routines written in the Java programming language, the JAVASCRIPT™ language, or the VBSCRIPT™ programming language, or some other suitable programming language. These embedded routines are used to execute the aforementioned HTTP, and/or HTTPS requests (e.g., GET, PUT, and DELETE) for web pages. For example, a web page or server page may allow a user to purchase keywords for an advertisement.

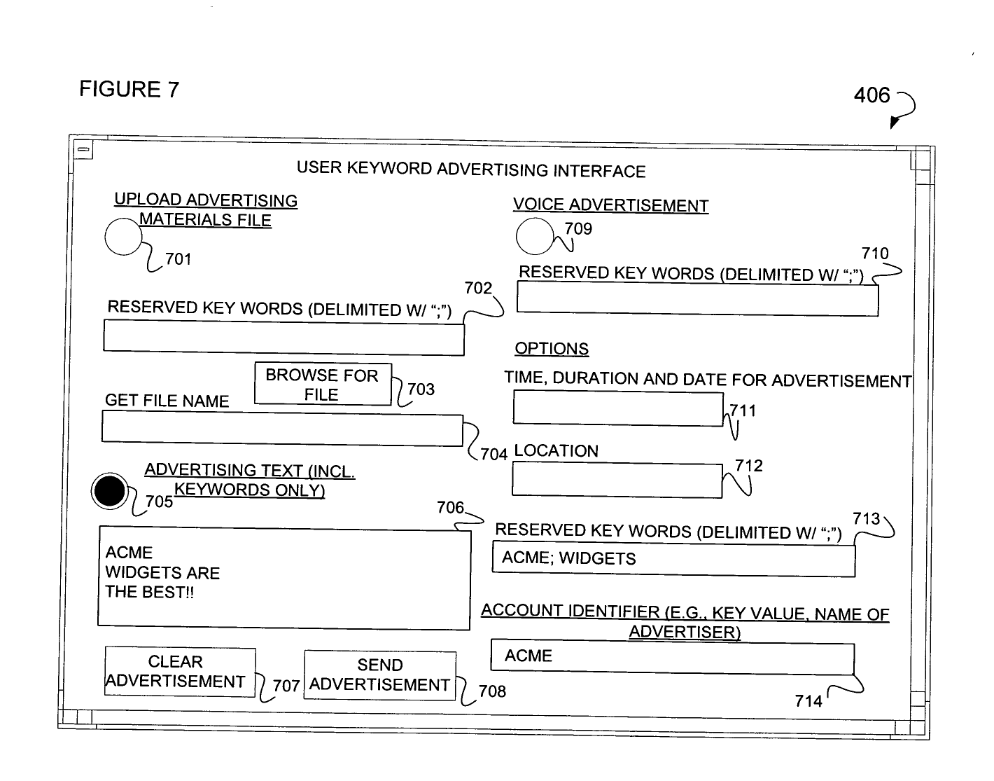

Some example embodiments may include, for example, a Graphical User Interface (GUI) used and implemented via a Java Servlet, Applet, or VBSCRIPT™ or C#™ form, or some other suitable programming language. This form may reside on one or more of the devices 119 as a client application. Moreover, this form may contain objects such as text boxes, buttons, scroll-down bars, widgets, or some other suitable dynamic interface object. These objects, and the routines governing them, allow a user to retrieve, input, or delete data, just to name few of the functions. For example, a form may allow a user to purchase keywords associated with an advertisement. (See e.g., FIGS. 7 & 9).

FIG. 7 is an interfaced illustrating an example keyword advertising interface 406. Illustrated are various objects and widgets associated with this user keyword advertising interface 406. For example, a radio button 701 is illustrated wherein once activated advertising materials in the form of a file may be uploaded. Associated with this radio button 701 is a text box 702 wherein certain reserved keywords also known as selected advertising keywords may be inputted and delimited with, for example a semi-colon (“;”). As previously illustrated, the selected advertising keywords may include the name “widget”, “Acme” or some other suitable advertising keyword used uniquely to distinguish one advertisement from another. Also associated with this radio button 701 and text box 702 is a button 703 used to initiate the browsing of a persistent or non-persistent storage medium residing on one or more of the devices 215. An advertising materials file may be selected using this button 701 and/or a description of it manually entered in the text box 702 and 704 to select this advertising materials file for uploading. Further illustrated as a part of this user keyword advertising interface 406, is a radio button 705 entitled “advertising text including keywords only.” Once this radio button 705 is selected, a text box 706 may be utilized to enter the text of an advertisement and/or keywords associated with this advertisement. Further, a text box 713 is illustrated that allows a user such as user 201 to select certain advertising keywords. Additionally, a radio button 709 is illustrated entitled “voice advertisement.” Associated with this radio button 709 is a text box 710 for certain reserved keywords. Utilizing the radio button 709, a user such as user 201 may choose to select certain advertising keywords that are associated only with a particular voice recording transmitted across, for example, a network 103 as part of an advertisement 102. In such a scenario, an advertisement is transmitted and once received by, for example, the search provider 113, this voice advertisement is parsed into its constituent parts. Select keywords and geographical information contained within this advertisement 102 are selected out and stored for future use. These keywords may be stored into, for example, a keyword database 208. Further, utilizing the user keyword advertising 406, for example, the user 201 may be able to utilize a text box 711 to note the time, duration and date for a particular advertisement such that the user 201 may be able to instruct the search provider 113 on the particular time period during which certain selected advertising keywords may be utilized by the search provided 113 in providing search results. Also a text box 712 was provided wherein a user such as user 201 may be able to input the geographical location information into the system directly without having to rely upon, for example, the IP address associated with the device the user 201 is utilizing to send the advertisement or without having to rely upon, for example, the parsing function associated with parsing a voice advertisement to determine or otherwise reveal the geographical information associated with, for example, an advertisement 102. In addition to the various options illustrated with text box 711 and 712, the user keyword advertising interface 406 may allow an account to be identified by account advertiser name. Text box 714 allows for a company to identify or otherwise associate keywords with its name. Once the radio button 701, 705 and/or 709 is executed, an advertisement button 708 may be further executed to actually send this data and the advertisement. Further, a clear advertisement button 707 may be implemented to allow a user such as user 201 to start a new search and upload, insert or otherwise utilize a voice advertisement.

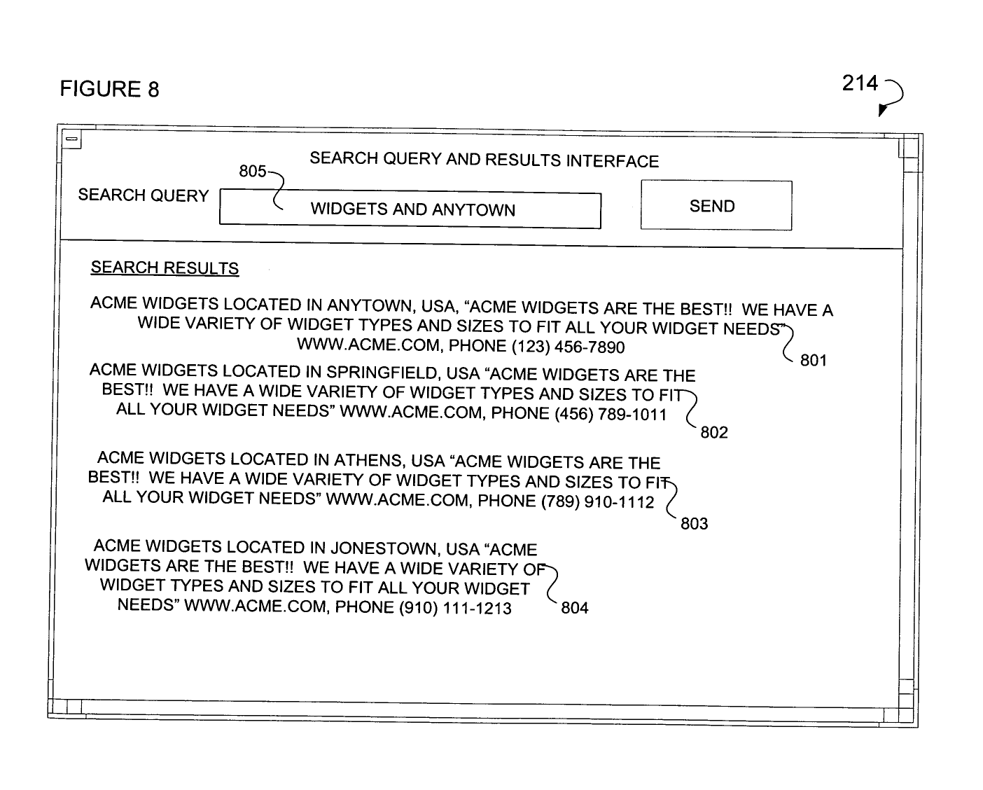

FIG. 8 is an interface illustrating an example search query and results interface 214. Illustrated is a text box 805 wherein a search query may be entered by, for example, a user 106. Once this search query is entered into the text box 805, a send button or other suitable input object or widget may be utilized to send the search query to a search provider. After being received by the search provider, the search provider utilizing a web server 210 and/or a search application server 209 may query, for example, a keyword database 208 during the process of returning search results. Here displayed is a search result 801 illustrating, amongst other things, a search result for Acme widgets in Anytown U.S.A. Ranked second is a second search result 802 illustrating Acme widgets locating in Springfield, U.S.A. A third search result is also depicted illustrating Acme widgets in Athens, U.S.A. illustrated here as 803. Lastly, a fourth search result illustrating Acme widgets as residing in Jonestown, U.S.A., referenced herein as 804. The first search result 801 denotes Acme and widgets in Anytown, U.S.A., and provides both a web address and a telephone number for this company. Also illustrated is an advertisement for this company. This geographical location Anytown and the name of the product and company that sells the product (Acme and widgets) corresponds to the initial advertisement 102 and the information provider that provided that advertisement (e.g., “located in Any Town, U.S.A. Acme widgets are the best!!”).

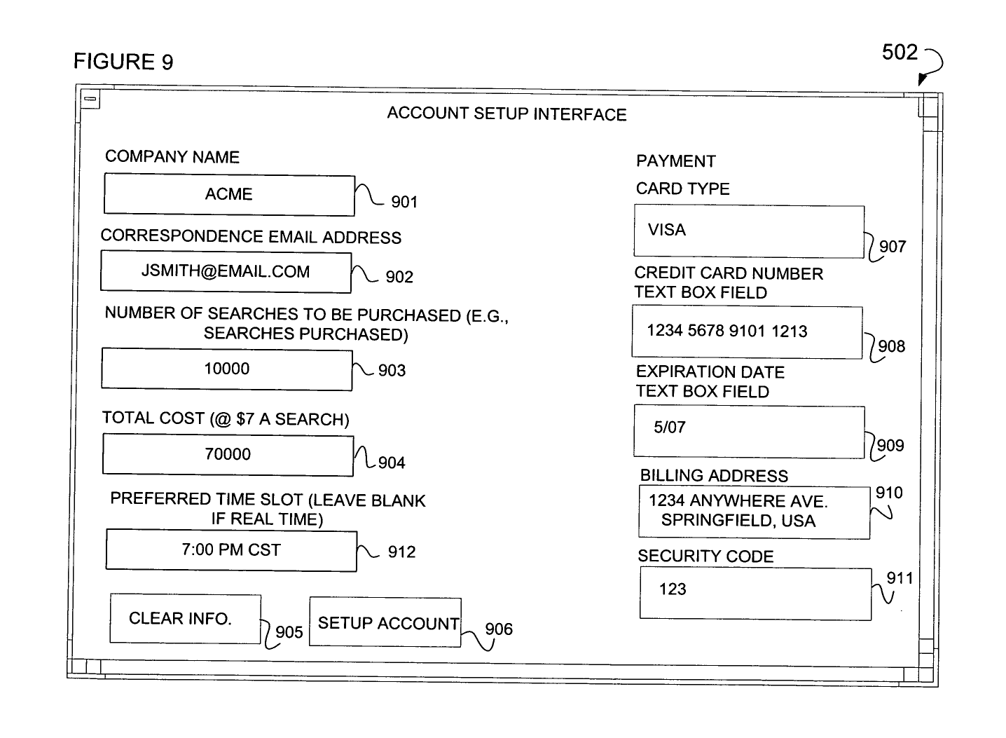

FIG. 9 is an interface illustrating an example account interface 502. Illustrated are a variety of text boxes utilized to receive input relating to setting up an account on, for example, the system 200, 300, and/or 400. A text box 901 receives company name information which here is “Acme”. A second text box 902 receives corresponding e-mail information which here is J. Smith at email.com. A third text box 903 receives the number of searches to be purchased by the party setting up the account which here is $10,000. A fourth text box 904 denotes the total cost for the search as requested in text box 903, which here is $70,000. In some embodiments, the cost per search is $7, $8 or some other suitable amount to be determined by a company implementing this account setup interface 502 or purchasing a service utilizing this interface. Further, a text box 912 is illustrated wherein a party setting up an account can denote the preferred time slot wherein their selected advertising keywords may be used to establish priority in a search result. Here 7:00 p.m. central standard time has been setup as a preferred time slot. Also illustrated is a text box 907 that denotes a payment card type which here is VISA™, a credit card number text box field 908 wherein a user setting up an account can enter a credit card number, a text box 909 where the expiration date of the particular credit card can be entered, a billing address text box 910 where a billing address for the particular credit card utilized can be entered and finally a security code text box 911 that contains security code information for the particular credit card being used. In addition, a screen object or widget in the form of a button 906 may be used to actually send the data entered into the various text boxes (e.g., 901-904, 912, 907-911). Further, a user such as user 501 may choose to clear the setup account information contained in the various text boxes by utilizing a button 905. In lieu of, or in addition to, the use of the credit card as a method of payment in this particular account setup interface 502 other forms of payment may be utilized including checks, money orders, internet payment systems (e.g., PAYPAL™) or some other suitable payment type.

In some embodiments, the number of searches, total cost value, credit card info and other info. (see generally 901-911) may be recorded into the database 208 and associated with example the keywords, IP addresses, physical location, and URL data contained therein. In other cases, a separate database is maintained for such information. This separate database may be operated by the above referenced internet payment systems.

### Logic Level

Some example embodiments may include the above illustrated web pages, and/or server pages being stored on one or more remote server computers connected to the client computer via an Internet. These remote servers can be a web server and/or application server. Web servers running JSP™ can include the APACHE™/APACHE TOMCAT™ web server. Web servers running ASP™ can include a Microsoft WINDOW WEB SERVER 2003™ utilizing Internet Information Services (IIS). Application servers running JSP™ can include the Orion Application Server or other J2EE™ certified application servers. Application servers running ASP™ can include WINDOWS SERVER 2003™. For example, a web server may serve a web page over a network that allows a user to enter in data. This data is then passed to an application server, wherein various methods illustrated below are applied to this data.

In some embodiments, the Logic level may be governed by a rule set written in a scripting language that controls how and when certain web pages, server pages, or pieces of content are provided to, or made accessible to, a particular user. This scripting language can be in the form of Java, Perl, Python, or some other general purpose scripting language. For example, once the logic of a JSP™ determines that a particular object (e.g., a text box) on a web page has been executed (e.g., a keyword purchase request is entered and sent), the data from this text box is inputted and sent to a web and/or application server. The routine written in a scripting language determines whether, for example, the keyword data is valid (e.g., that a keyword has been properly entered). Some example embodiments may further include a routine written in a scripting language to retrieve data from a storage, data structure, or database level. The Storage level may be run by a separate database application, while, in other embodiments, a database embedded with a Logic level may be implemented (e.g., a Native database).

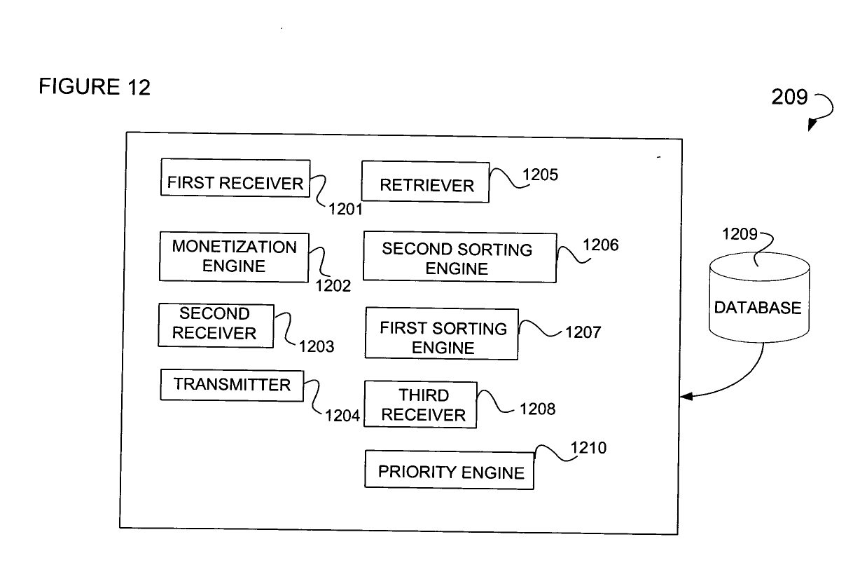

In some embodiments, the above illustrated client application forms may be used to interact with a Logic level. For example, a C# form may take in data from a user and pass it to one of the above illustrated web and/or application servers. Once passed to one of these servers via a network connection, various methods as illustrated below may be applied to the data. (See e.g., FIGS. 12-23).

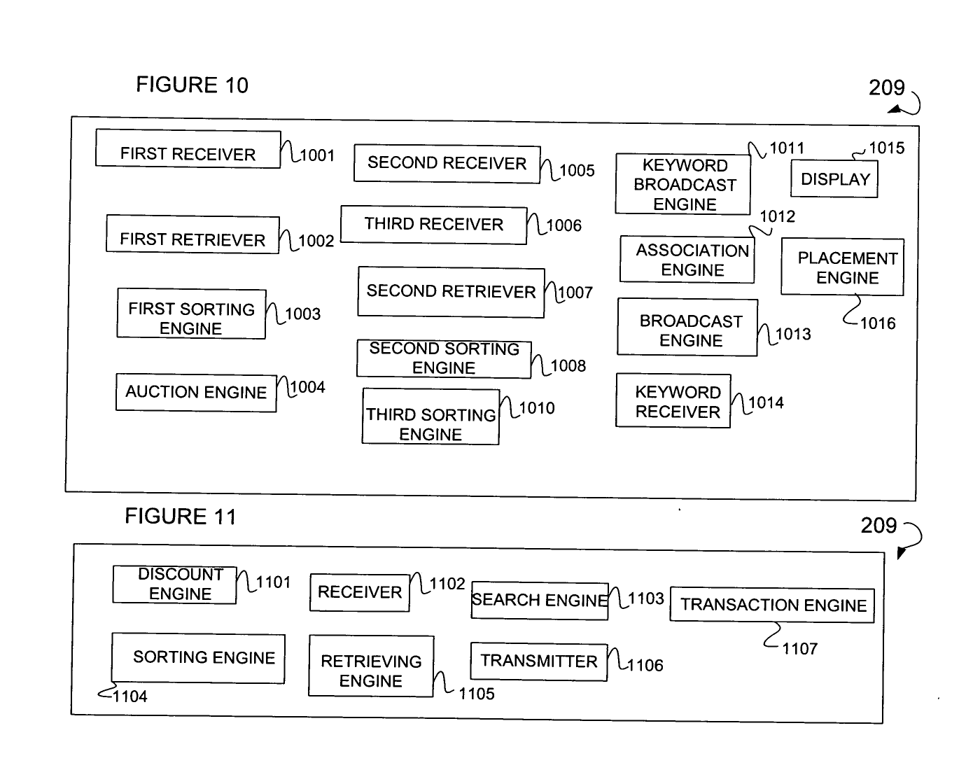

FIG. 10 is a block diagram illustrating the various modules that may reside on an example search application server 209. These various modules may be implemented in hardware, firmware, software, or some other suitable medium. Illustrated is a computer system including a first receiver 1001 to receive a search query containing a selected advertising keyword, a first retriever 1002 to retrieve a search result using the search query, the search result corresponding with the selected advertising keyword, and a first sorting engine 1003 to sort the search result using the selected advertising keyword, giving priority to the selected advertising keyword using a monetizing of the selected advertising keyword. In some embodiments, the selected advertising keyword is contained in an advertisement. Additionally, the advertisement is transmitted across a network, the network including at least one of a radio network, a television network, a cable network, or an internet network. Further, the monetizing includes associating a monetary value with the selected advertising keyword, the monetary value including at least one of a discount value, a premium value, an auction value, or a market value. Moreover, in some embodiments, an auction engine 1004 is used to set the auction value on the basis of competing bids between advertisers relating to the selected advertising keyword. In some cases, the computer system includes a second receiver 1005 to receive the search query and determine a first geographical location relating to a party generating the search query, a third receiver 1006 to receive the selected advertising keyword and determine a second geographical location relating to an advertiser, a second retriever 1007 to obtain the search result in response to the search query based, in part, upon the correspondence between the geographical location of the party generating the search query and the advertiser, and a second sorting engine 1008 to sort the search result using the monetizing of the selected advertising keyword. In certain cases, the first and second geographical location is determined by analyzing an IP address. A third sorting engine 1010 may be part of the computer system, sorting using at least one criteria, wherein the criteria includes at least one of highest Return On Investment (ROI), search result with the highest airplay on the network, and advertisements played by broadcast stations with the highest industry ratings. Further, the highest industry ratings include at least one of Arbitron ratings and Nielsen ratings.

FIG. 11 is a block diagram illustrating the various modules that may reside on an example search application server 209 applying various metrics to evaluate an advertisement. These various modules may be implemented in hardware, firmware, software, or some other suitable medium. Some embodiments may include a computer system, including a sorting engine 1104 to sort a group of broadcast advertisement search results using a broadcast metric, the broadcast metric providing a basis to place a member of the group of broadcast advertisement search results in a higher position relative to at least one other member of the group of broadcast advertisement search results. Also included may be a transmitter 1106 to transmit the group of broadcast advertisement search results as a sorted group. The group of broadcast advertisement search results includes at least one of a radio broadcast advertisement, television broadcast advertisement, or internet broadcast advertisement. Additionally, the broadcast metric includes at least one of ad revenue generated by a broadcast advertisement during a specific time frame, an ad budget spent on the broadcast advertisement during a specific time frame, or a number of impressions during a specific time frame, where the number of impressions are a function of the number of people who have been presented the broadcast advertisement. Moreover, the broadcast metric may include at least one of an estimated number of listeners in a listening timeframe, an estimated number of viewers in a viewing timeframe, or an estimated number of online users accessing a content in an online availability timeframe. Further, the listening timeframe is hourly, daily, or weekly, wherein the listening timeframe includes at least one of a morning time slot, an evening time slot, a rush-hour time slot, or a prime-time time slot. Additionally, the viewing timeframe is hourly, daily, or weekly, and the viewing time frame includes at least one of a prime-time time slot, a day-time time slot, or an after-hours time slot. In some embodiments, the sorting of the group of broadcast advertisement search results is a function of the broadcast metric and a placement fee, wherein the placement fee is used to place the member of the group of broadcast advertisement search results in a higher position relative to at least one other member of the group of broadcast advertisement search results. Example embodiments may include a discount engine 1101 to discount a price of the paid placement, the discount based upon a number of paid placements purchased. Moreover, in some embodiments, this discount engine 1101 may attach a premium to a price of the paid placement, the premium based upon a number of paid placements relating to a particular advertising space. Example embodiments may include a computer system further including a receiver 1102 to receive a search query, the search query including a term relating to a broadcast advertisement, a search engine 1103 used to search a data store, and a retrieving engine 1105 to obtaining the group of broadcast advertisement search results. Additionally, the broadcast metric may provide a basis to place a member of the group of broadcast advertisement search results in a lower position relative to other members of the search results.

FIG. 12 is a block diagram illustrating the various modules that may reside on an example search application server 209 seeking to monetize various selected advertising keywords. These various modules may be implemented in hardware, firmware, software, or some other suitable medium. Illustrated is a system including a first receiver 1201 residing on a computer system, to receive selected advertising keywords, wherein the selected advertising keywords are taken from an advertisement transmitted across a network, a monetization engine 1202, residing on the computer system, to monetizing the selected advertising keywords, and a database 1209 operatively coupled to the computer system, to store the selected advertising keywords into a database. In some embodiments, the monetizing is based upon various criteria including at least one of selected keyword activity, or selected keyword ranking. Further, the network may include at least one of a radio network, television network, cable network, or internet network. Some embodiments may include a second receiver 1203 residing on the computer system, to receiving a search query containing selected advertising keywords, a retriever 1205 residing on the computer system, to retrieve the selected advertising keywords, a first sorting engine 1207 residing on the computer system, to sort the selected advertising keywords, giving priority to certain selected advertising keywords based upon the monetizing of the selected advertising keywords, and a transmitter 1204 residing on the computer system, to transmitting the selected advertising keywords. Moreover, the system may include a priority engine 1210 residing on the computer system, to give priority to certain selected advertising keywords based upon a payment made by an advertiser. Additionally, a second receiver 1203 may receive a search query, and determining a first geographical location relating to a party generating the search query, a third receiver 1208 residing on the computer system, to receiving the selected advertising keywords, and determining a second geographical location relating to an advertiser, a retriever 1205 residing on the computer system, to obtaining a search result in response to the search query based, in part, upon the correspondence between the geographical location of the party generating the search query, and the advertiser, a second sorting engine 1206 residing on the computer system, to sort the search result based upon the monetizing of the selected advertising keyword, and a transmitter 1204 residing on the computer system, to transmit the search result to the party generating the search query. In certain cases, the geographical location is determined by analyzing an IP address. The system may include a second sorting engine 1206 that sorts based upon some criteria, the criteria is selected from the group of criteria consisting of highest ROI, search results with the highest airplay on the network, and advertisements played by broad cast stations with the highest industry ratings. Moreover, the highest industry ratings may include at least one of Arbitron ratings, and Nielsen ratings.

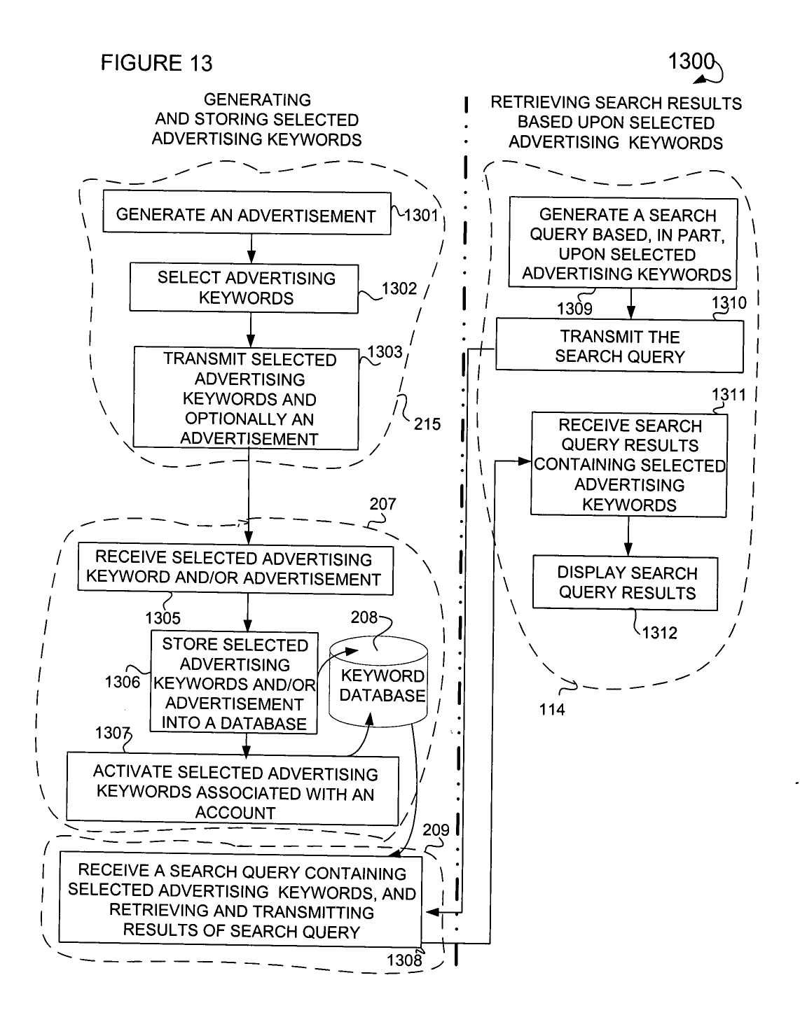

FIG. 13 is a dual stream flowchart illustrating an example method 1300 illustrated as a first stream entitled “generating and storing selected advertising keywords” and a second stream entitled “retrieving search results based upon selected advertising keywords.” Illustrated in the first stream are various operations executed by various devices, for example, operations 1301 through 1303 may reside on one of the devices previously illustrated as 215. Moreover, operations 1305 through 1307 may reside on, for example, an application server 207. Further, an operation 1308 may execute on a search application server 209.

Starting with the module 1301, an advertisement may be generated utilizing the operation 1301. Once generated, this advertisement may be sent to an operation 1302 to allow for the selecting of certain advertising keywords. After these advertising keywords are selected, they are transmitted using an operation 1303 across a network, such as network 103, to an application server 207, wherein they are received by an operation 1305. In addition to the transmitting of select advertising keywords by the operation 1303, the actual advertisement may also be transmitted. The operation 1305 receives the select advertising keywords or advertisement. These advertising keywords may be part of, for example, the data packets 306 and 408. Also received by this operation 1303 may be the data packet 307 and 404. Once received, these select advertising keywords and/or advertisement are sent to an operation 1306 where they may be stored into a database 208. Stored into the database 208 may be the keyword associated with certain identifying information such as the IP address associated with the advertisement, a URL corresponding to the IP address, a key value (e.g., key 505) or other identifying information. An operation 1307 may activate these advertising keywords. Once the selected advertising keywords have been stored into a database 208, this database 208 may be queried by an operation 1308, wherein the module 1308 may receive a search query containing select advertising keywords from, for example, a user 201. These select advertising keywords are then received by the module 1308 and a query is made of the database 208 utilizing these selected advertising keywords to obtain a search result. Once obtained, a search result may be transmitted back to the user 201 utilizing one of the devices 114 in the form of a search query result.

With respect to the second stream of this dual stream flowchart various operations are illustrated (e.g., 1309-1312) as residing on one of the devices 114 For example, an operation 1309 is illustrated that generates a search query based, in part, upon a second advertising keyword. Once the search query is generated it is sent to an operation 1312, wherein it is transmitted to the module 1308 across, for example, a network 205. Once transmitted across the network 205, the module 1308 may retrieve a search result based upon the search query by the previously illustrated query of the database 208, and transmit this search result back across the network 205 to an operation 1311 residing on one of the devices 114. The module 1311 then takes this search query result and sends it to an operation 1312 for display. As previously illustrated, the generation of an advertisement (e.g., 1301) may occur as a result of, for example, the utilization of the microphone 202 or, for example, through the utilization of a user keyword advertising interface 406. Further, the generating of a search query may be conducted utilizing a search query and a result interface 214, wherein the module 1309 is implemented utilizing, in some cases, the search query and result interface 214.

Some embodiments may include executing operation 1305 along with subsequent operation such that a search query is received, the search query including a term relating to a broadcast advertisement, using the search query to search a data store, and obtaining the group of broadcast advertisement search results. This broadcast metric may provide a basis to place a member of the group of broadcast advertisement search results in a lower position relative to other members of the search results during sorting.

In some embodiments may include executing an operation 1305 and subsequent operations and receiving a search query containing a selected advertising keyword, retrieving a search result using the search query, the search result corresponding with the selected advertising keyword and sorting the search result using the selected advertising keyword, giving priority to the selected advertising keyword using a monetizing of the selected advertising keyword. The selected advertising keyword may be is contained in an advertisement wherein the advertisement is transmitted across a network to the operation 1305, the network including at least one of a radio network, a television network, a cable network, or an internet network.

Example embodiments may include executing an operation 1305 and subsequent operations to receive a search query, and determining a first geographical location relating to a party generating the search query, receiving the selected advertising keyword, and determining a second geographical location relating to an advertiser, obtaining the search result in response to the search query based, at least in part, upon the correspondence between the geographical location of the party generating the search query and the advertiser, and sorting the search result using the monetizing of the selected advertising keyword. The first and second geographical locations may be determined by analyzing an IP address.

In some embodiments, a method is illustrated wherein an operation 1303 is executed and an advertisement is broadcast containing one or more keywords, and an operation 1305 is executed to receive a search query at a search engine, the search query containing the one or more keywords. A higher fee is then charged, than would normally be charged, relating to placement of the one or more keywords in a search result, the higher fee charged during a time offered broadcast advertisement.

Some embodiments may include a method implemented through the execution of operation 1303 wherein an advertisement is broadcast containing one or more keywords, the advertisement relating to a first product, receiving a search query at a search engine via an operation 1305. The search query may contain the one or more keywords, and a higher fee may be charged, than would normally be charged, relating to placement of a keyword contained in an advertisement for a second product related to the first product, the higher fee charged after the broadcasting.

In some embodiments, operation 1303 is executed so as to broadcast an advertisement to facilitate keyword searches on a search engine during a period of time following a broadcast, and a further operation is executed (e.g., operation 1307) to sell an advertising placement during the period of time based on an audience size drawn to the search engine. FIG. 9 shows an example account setup interface to used to sell these an advertising placement.

Example embodiments may include executing an operation 1303 to broadcast an advertisement, the advertisement tailored to draw a particular audience to a search engine, and using the example account set up interface in FIG. 9 to sell an advertising placement to an advertiser seeking to reach the particular audience.

Some embodiments may include executing an operation 1305 to receive a selected advertising keyword, wherein the selected advertising keyword is associated with an advertisement transmitted across a network, monetizing the selected advertising keyword, and storing the selected advertising keyword in a database such as database 208.

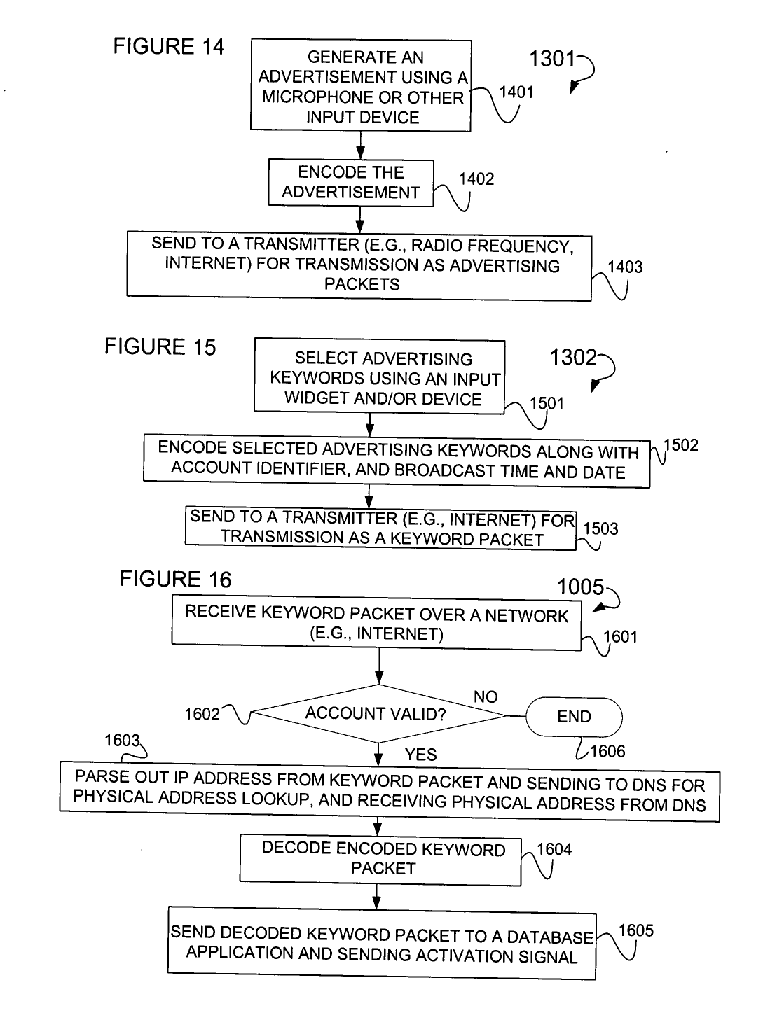

FIG. 14 is a flowchart illustrating an example method used to implement an operation 1401. Illustrated is an operation 1401 used to generate an advertisement using, for example, a microphone or other input device. Once this advertisement is generated, it is sent to an operation 1402 for encoding, and then to an operation 1403 to transmit this encoded advertisement across a network such as network 103. After transmission, the encoded advertisement may be ultimately received by, for example, a search provider 113.

FIG. 15 is a flowchart illustrating an example method used to implement an operation 1302. Illustrated is an operation 1501 that facilitates the selecting of advertising keywords utilizing an input widget and/or device. This selection of advertising keywords occurs using an operation 1502 that encodes the selected advertising keywords along with an account identifier and, for example, broadcast time and date. As previously illustrated, this account identifier may be, for example, the name of the party generating the selected advertising keywords or may be, for example, a digital signature in the form of a symmetric, asymmetric or highbred crypto key provided at account setup time. This key may be, for example, a key 505. Once module 1502 is executed, an operation 1503 is executed that transmits the encoded selected advertising keywords along with the other information, including account information and a broadcast time and date information, across a network such as network 103.

FIG. 16 is a flowchart illustrating an example method used to implement an operation 1305. Illustrated is an operation 1601 that receives a keyword packet over a network such as an internet (e.g., 103). Once this module 1601 is executed, a decisional module 1602 is executed that determines the validity of the keyword packet received. In cases where decisional module 1602 evaluates to false (e.g., “no”), then an end module 1606 is executed wherein the keyword packet is discarded. In instances where the decisional module 1602 evaluates to true (e.g., “yes”) an operation 1603 is executed that parses out, for example, an IP address from the keyword packet and sends this IP address to the DNS server for a lookup of the physical address associated with the IP address. Next, the physical address information is then transmitted by the DNS (e.g., DNS 305). An example system implementing this process is illustrated in FIG. 4. Once the physical address is received, the module 1604 is executed. An operation 1605 is executed that send a decoded keyword packet to a database application along with the physical address information and other related information. Further, in some cases, an activation signal is sent in response to the saving of the decoded keyword packet to a database application. This database and associated application may be, for example, the keyword database 208.

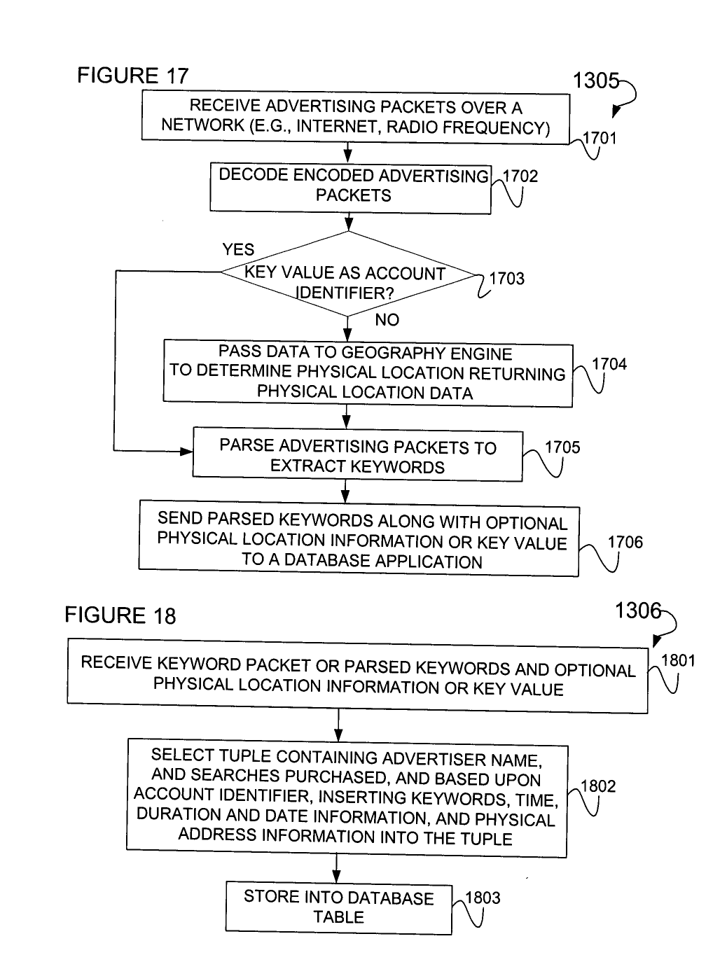

FIG. 17 is a flowchart illustrating an example method used to implement an operation 1305. Illustrated is an operation 1701 that receives advertising packets over a network such as, for example, an internet or radio frequency network. Once received, an operation 1702 is executed that decodes the encoded advertising packets. Once decoded, a decisional module 1703 is executed. In cases where decisional operation 1703 evaluates to “no” (e.g., true), an operation 1704 is executed that passes data taken from the advertising packet to a geography engine to determine the physical location associated with the data containing the advertising packet. For example, if the word Minneapolis is mentioned or otherwise disclosed in the advertising packet or packets, then Minneapolis may be presumed to be the geographical location or physical location associated with the advertising packet. Once this geography engine returns a geographical location associated with the advertising packet, this physical location is then passed to an operation 1705 that parses the advertising packet to extract certain selected advertising keywords. Once extracted, an operation 1706 is executed that sends the parsed keywords along with physical location information or, in some cases, a key value (e.g., key 505) to database application such as database 208. In cases where the decisional module 1703 evaluates to “yes” (e.g., false), then the operations 1705 and 1706 execute as illustrated above.

FIG. 18 is a flowchart illustrating an example method to implement an operation 1306. Illustrated is an operation 1801 that receives a keyword packet (e.g., data packets 306, and 408), physical location information (e.g., data packets 307, and 404), parsed keywords, and/or key value (e.g., key 505) information. Once received, the module 1802 is executed. In some cases, this module 1802 may generate a new tuple entry and insert it into a database based upon the received keyword packet and related information illustrated in 1801. In other cases, however, an existing tuple entry may be updated, wherein a tuple entry is identified using an account identifier such as a keyword value and, once it is identified, the tuple is updated by inserting keywords, time, duration and time information and, for example, physical address information. Once this tuple is generated and/or updated, it is stored into a database such as database 208 utilizing an operation 1803 as may be more fully illustrated below. A Structured Query Language (SQL) may be used to implement module 1802.

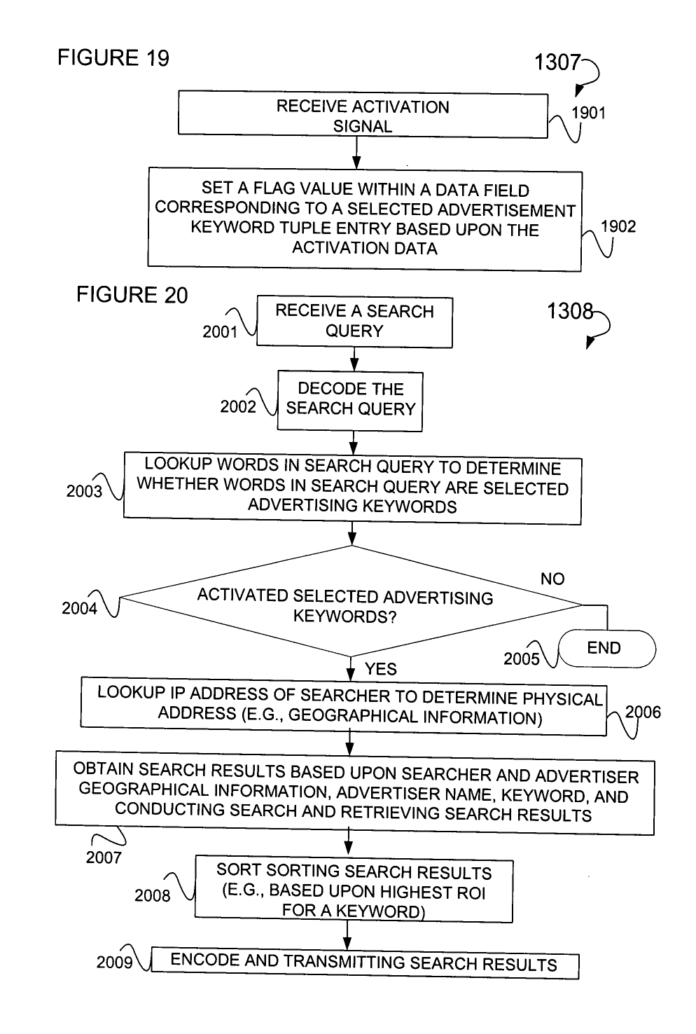

FIG. 19 is a flowchart illustrating an example method used to implement an operation 1307. Illustrated is an operation 1901 that receives an activation signal. Once received, an operation 1902 is executed that sets a flag value within a data field corresponding to a selected advertising keyword tuple entry based upon activation data. In some cases, a user such as user 201 may choose to upload certain selected keywords into the system but may choose to activate these keywords for the purposes of searching at a later point. Activation may take the form of, for example, a particular date and time corresponding to an existing or present date and time or may be in the form of just, for example, a flag value. The flag value can be either an “off” or “on” position such that, in cases where the flag is in the “on” position, searches conducted may return results based upon the selected advertising keywords so long as the account used to setup the selected advertising keywords has not been exhausted in terms of the number of searches that can be conducted. For example, if 10,000 searches have been conducted for the selected keywords utilized by the Acme company as illustrated in account setup interface 502, then the activation flag may switch from being active to inactive such that the search queries utilizing the selected advertising keywords may no longer be given priority in the search results.

FIG. 20 is a flowchart illustrating an example method used to implement an operation 1308. Illustrated is an operation 2001 that receives a search query. Once received, an operation 2002 is executed that decodes the search query. The decoded search query is then passed to module 2003, wherein a lookup of words in the search query is conducted to determine whether the words are selected advertising keywords. After this lookup occurs, a decisional module 2004 is executed wherein if the decisional module 2004 evaluates to “no”, then an operation 2005 may be executed wherein the search query may be discarded. In cases where the decisional module 2004 evaluates to “yes”, an operation 2006 may be executed wherein a lookup of an IP address of the searcher may occur to identify the searchers and/or device such as devices 114 utilized by the searcher, such as user 106, to determine their physical or geographical location. Once the physical or geographic location is determined, the module 2007 is executed to obtain search results based on the searcher and advertiser's geographical location. That is, a search result may be sought that is based upon a correspondence between the searcher's and the advertiser's geographical location and based upon the advertiser name keyword and related information. Upon obtaining the search result, the result is sorted based upon, for example, ROI. Put another way, when executed, operation 2008 may seek to maximize the value or ROI for a particular organization or company implementing operation 2008. Once sorted, an operation 2009 is executed that encodes and transmits the search results to, for example, the user 106 utilizing a search query and result interface 214.

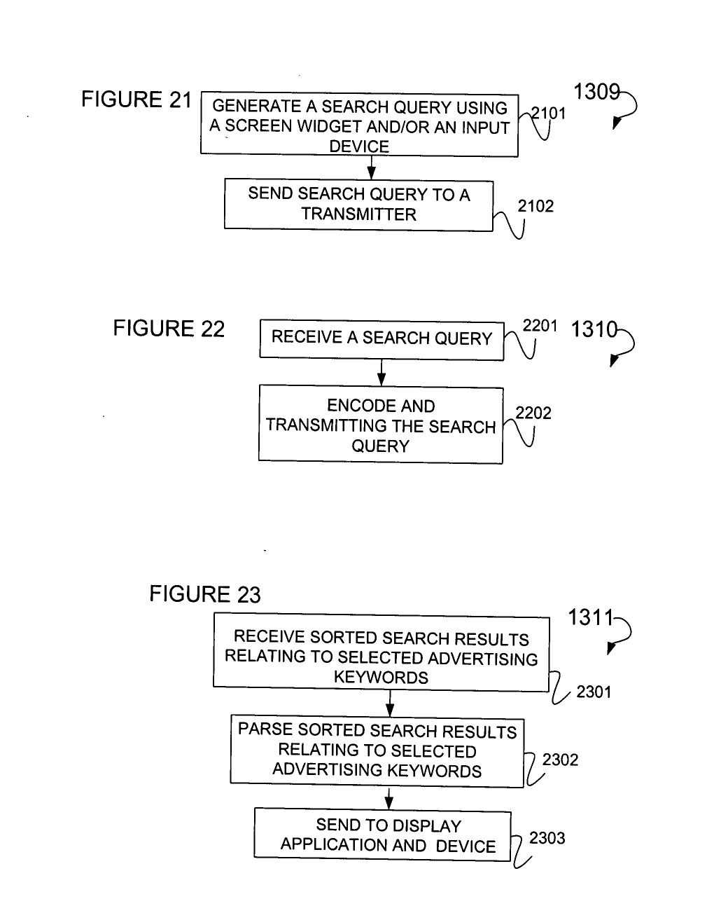

FIG. 21 is a flowchart illustrating an example method used to implement an operation 1309. Illustrated is an operation 2101 that allows for the generation of a search query utilizing a screen widget and/or input device. Once generated this search query is sent to an operation 2102, where a search query is sent to a transmitter.

FIG. 22 is a flowchart illustrating an example method used to implement an operation 1310. Illustrated is an operation 2201 that receives a search query. This search query may be received from, for example, operation 1309. Once received, the operation 2202 is executed that encodes and transmits the search query. This encoded and transmitted search query may be sent across, for example, a network such as network 103 to a search provider 113. With respect to issues and encoding, in some cases, this search query may be encoded using any one of the numerous protocols utilized in, for example, an internet. For example, this search query may be encoded utilizing HTTP and various associated methods such as “put”, “get” or other methods used to upload or send content from a first device operatively coupled via an internet, to a second device operatively coupled to an internet. In some cases, this first device may be any one of the devices 114 whereas the second device may be, for example, be a web server such as web server 206.

FIG. 23 is a flowchart illustrating an example method used to implement an operation 1311. Illustrated is an operation 2301 that receives sorted search results relating to select advertising keywords. Once received, operation 2302 is executed that parses the sorted search results related to selected keywords. This parsing may be based upon certain grammatical rules relating to the anticipated received sorted searching results. The grammatical rules may be based upon, for example, a grammar associated with a hypertext markup language or an extensible markup language or some other suitable language. Once parsed, an operation 2303 is executed that displays these parsed, sorted search results on some type of application and device that would implement an application. For example, an internet browser may display parsed HTML code on, for example, a computer screen.

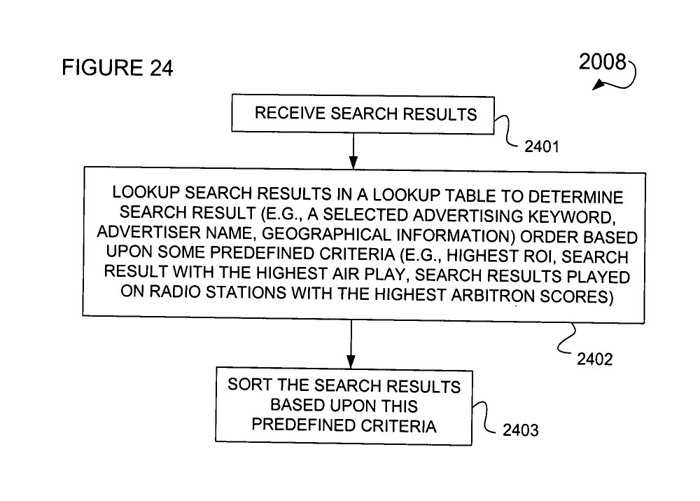

FIG. 24 is a flowchart illustrating an example method used to implement an operation 1908. Illustrated is an operation 2401 that receives a search result. Once received, the operation 2402 is executed wherein a search result is looked up in a lookup table to determine the priority the search result should be given during the course of sorting. For example, a search result may be sorted based upon the highest ROI associated with the particular sort, the highest air play that a particular advertisement associated with the search result has received or even, for example, such types of performance matrix such as Arbitron, Nielsen scores, or other ways of evaluating content provided or otherwise generated by a broadcasting station such as broadcasting station 101. Once the search result with the highest value based upon one of these predefined criteria is determined, a sort of the search results occurs based upon the predefined criteria as reflected by operation 2403. Once sorted these results are then transmitted for viewing by, for example, user 106.

Some embodiments may include ROI as defined by a monetary value including a discount value, a premium value, an auction value, or a market value. An auction value may be set on the basis of competing bids between advertisers or buyer of keyword relating to the selected advertising keyword. Further, the sorting of the keywords by operation 2403 may be based upon search result with the highest airplay on the network, and advertisements played by broadcast stations with the highest industry ratings, wherein the highest industry ratings include at least one of Arbitron ratings and Nielsen ratings.

Example embodiments may include executing an operation 2403 to sort a group of broadcast advertisement search results using a broadcast metric, the broadcast metric providing a basis to place a member of the group of broadcast advertisement search results in a higher position relative to at least one other member of the group of broadcast advertisement search results and transmitting the group of broadcast advertisement search results as a sorted group. These broadcast advertisement search results may include at least one of a radio broadcast advertisement, television broadcast advertisement, or internet broadcast advertisement. Further, the broadcast metric may include at least one of ad revenue generated by a broadcast advertisement during a specific time frame, an ad budget spent on the broadcast advertisement during a specific time frame, or a number of impressions during a specific time frame, where the number of impressions are a function of the number of people who have been presented the broadcast advertisement. Moreover, the broadcast metric may include at least one of an estimated number of listeners in a listening timeframe, an estimated number of viewers in a viewing timeframe, or an estimated number of online users accessing content in an online availability timeframe. The listening timeframe may be hourly, daily, or weekly, and includes at least one of a morning time slot, an evening time slot, a rush-hour time slot, or a prime-time time slot. Further, the viewing timeframe is hourly, daily, or weekly, the viewing time frame includes at least one of a prime-time time slot, a day-time time slot, or an after-hours time slot.

Some embodiments may include the execution of an operation 2403 such that the sorting of the group of broadcast advertisement search results is a function of the broadcast metric and a placement fee, wherein the placement fee is used to place the member of the group of broadcast advertisement search results in a higher position relative to at least one other member of the group of broadcast advertisement search results. Additionally, a discounting of a price of the placement fee, the discounting based upon a number of paid placements purchased may occur. Moreover, a premium may be attached to a price of the placement fee, the premium based upon a number of paid placements relating to a particular advertising space.

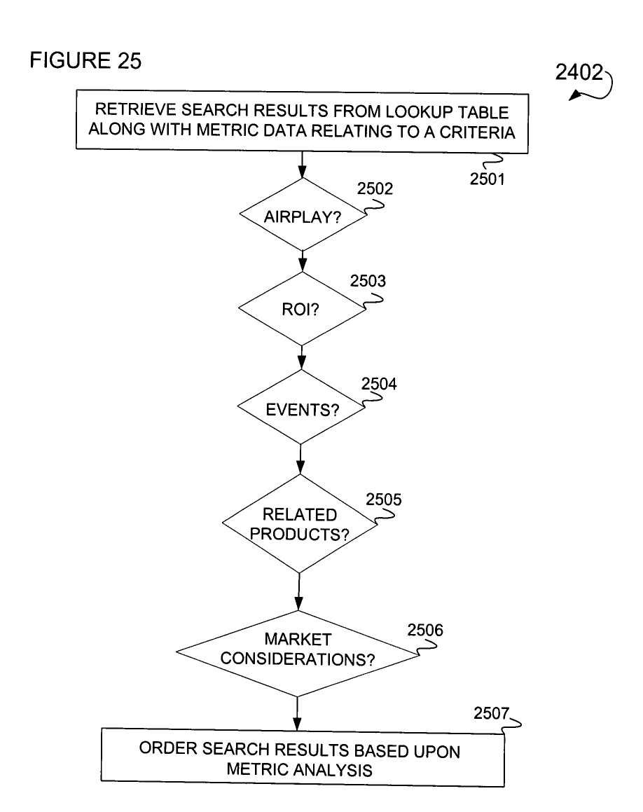

FIG. 25 is a flow chart illustrating an example method used to execute operation 2402. Illustrated is an operation 2501 that that retrieves metric data associated with a keyword used in an advertisement. This metric data may be, for example, discount values, premium values, auction values, Arbitron or Nielsen rating data, impression data, event data (e.g., popular events such as the Super Bowl, World Series, Stanley Cup etc.), related product data, or any other metric. Next, these metric are analyzed to determine an order for sorting, or sort order. This analysis can be implemented in a case statement wherein certain decisional operations (e.g., 2502-2506) can be used or not used (e.g., turned off/on for the purpose of analysis) depending on the requirements of, for example a keyword broker, or search engine provider selling keywords used in broadcast advertisements. Decisional operation 2502 may analyze the metrics for a determination of ranking based upon airplay (e.g., Arbitron, Nielsen ratings, impressions). Next, decisional operation 2503 may analyze based upon what keywords provide the highest, lowest, or some other defined ROI value. This ROI may be an ROI for the keyword broker, or a search engine provider. Then, decisional operation 2504 is executed to determine order based upon the association between the keywords contained in the advertisement and events occurring during or shortly after the airing of the advertisement. For example, if the keyword “football” has been purchased and seeks to have priority during the playing of the Super Bowl, then a premium may be changed for this keyword. Further, decisional operation 2505 is executed to determine what product advertisements, and associated keywords, are related to the keywords being ranked. These associated keywords may also be changed a premium based upon their association and may only be ranked higher relative to other key words, where this premium is paid. Decisional operation 2506 reflects certain market consideration that may need to be accommodated such as an auction value set for the keyword seeking to be sorted, discount, premium or other valuations. Operation 2507 may then sort based upon the analysis provided by decisional operations 2502-2506, give certain keywords a high order in the sort results based upon which analysis, or combination of analysis have been used or not used.

### Storage Level

Some embodiments may include a Storage level wherein tables of data are created, and data is inserted into and selected from, these tables using a Structured Query Language (SQL) or some other database-related language known in the art. These tables of data can be managed using a database application such as, for example, MYSQL™, SQLServer™, Oracle 81™ or 10G™, or some other suitable database application. These tables are organized into an RDS or Object-Relational-Database Schemas (ORDS), as is known in the art. These schemas can be normalized using certain normalization algorithms so as to avoid abnormalities such as non-additive joins and other problems. Additionally, these normalization algorithms include Boyce-Codd Normal Form or some other normalization, optimization algorithm known in the art. Some embodiments may include creating a series of database tables containing data related to keyword data. These tables could be distinguished based upon the author keyword information, or some other suitable means of distinguishing the keyword information.

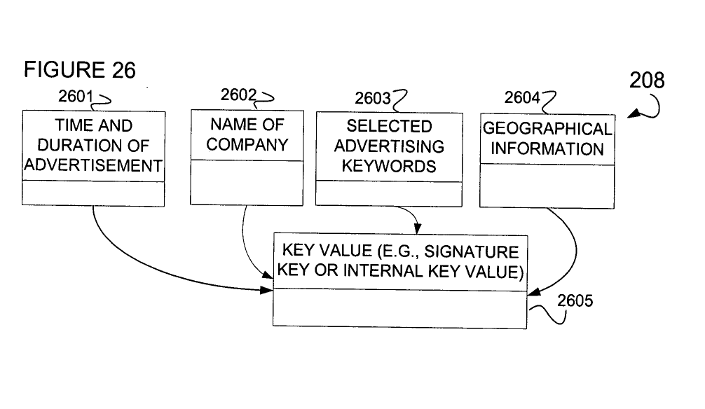

FIG. 26 is an RDS illustrating various database tables that may be implemented on or as part of the database 208. Illustrated is a database table 2601 entitled “time and duration of advertisement.” This database table may contain data relating to the time and duration of a particular advertisement wherein the time and data information may be one of many data types including an integer, string, float, or some other suitable data type. Next, a database table 2602, entitled “name of company”, is illustrated. This database table 2602 contains the name of the particular company that has set up an account to provide for priority for selected advertising keywords. Various data types may be used to store the name of the company including characters, strings, Character Large Objected (CLOB), or other suitable data types. Additionally illustrated is a table 2603 entitled “selected advertising keywords”. This table may contain selected advertising keywords that have been generated by an advertiser wherein the select advertising keywords may be a data type such as a string character or CLOB, for example. Further, a database table 2604 is illustrated entitled “geographical information”. This database table 2604 may contain geographical information relating to, for example, the location of a particular advertiser. This geographical location information may be in the form of an actual physical location such as Minneapolis, Minn. or may be in the form of, for example, an IP address, URL, or other suitable identifier used to identify geographical information associated with an advertiser. Cases where the actual physical location is given (e.g., Minneapolis, Minneapolis), a string or other suitable data type may be used. In cases where an IP address is used, an integer or series of integers used in conjunction with other types of characters may be utilized. Further illustrated is a table 2605 that is a key value such as, for example, a signature key or other internal key value. The key value may be used to uniquely identify a particular tuple associated with an advertiser and may be in the form of a numeric value and a data type for this numeric value such as, for example, an integer. In certain cases, this key value may dependent upon a key 505. Additionally, the database table 2605 may constitute an internal constraint for the RDS in general so as to uniquely identify various data sets or, for example, tuples within the RDS.

### Component Design

Some example embodiments may include the above illustrated three tiers or levels, and the operations disclosed therein, being written as one or more software components with each component contributing to the functionality of each level or tier. Common to many of these components is the ability to generate, use and manipulate the above-illustrated data and data sets. These components, and associated functionality, may be used by the client, server, or peer applications. These various components can be implemented into the system on an as-needed basis. These components may be written in an object-oriented-computer language such that a component oriented or object-oriented programming technique can be implemented using a Visual Component Library (VCL), Component Library for Cross Platform (CLX), Java Beans (JB), Java Enterprise Beans (EJB), Component Object Model (COM), or Distributed Component Object Model (DCOM) or other suitable technique. These components are linked to other components via various Application Programming Interfaces (APIs) and then compiled into one complete server and/or client application. The process for using components in the building of client and server applications is well known in the art. Further, these components, and the tiers that they make up, are linked together via various distributed programming protocols as distributed computing components.

### Distributed Computing Components

Some example embodiments may include remote procedure calls being used to implement one or more levels of a three-tier software architecture across a distributed programming environment. For example, a Logic level that resides on a first computer system may be remotely located from a second computer system containing an Interface or Storage level. These first and second computer systems can be configured in a server-client, peer-to-peer or some other configuration. These various levels can be written using the above illustrated component design principles and can be written in the same programming language, or a different programming language. Various protocols are implemented to enable these various levels, and components contained therein, to communicate regardless of the programming language used to write these components. For example, an operation written in C++ using the Common Object Request Broker Architecture (CORBA) or Simple Object Access Protocol (SOAP) can communicate with another remote module written in JAVA™. These protocols include SOAP and CORBA or some other suitable protocol. These protocols are well-known in the art.

### A System of Transmission Between a Server and Client

In some embodiments, the above illustrated components that make up the platform architecture communicate using the OSI or TCP/IP stack models for defining network protocols that facilitate the transmission of data. Applying these models, a system of data transmission between a server and client computer system can be illustrated as a series of roughly five layers comprising as a: physical layer, data link layer, network layer, transport layer and application layer. Some example embodiments may include the various levels (e.g., the Interface, Logic and Storage levels) residing on the application layer of the TCP/IP protocol stack. The present application may utilize HTTP to transmit content between the server and client applications, whereas in other embodiments another protocol known in the art is utilized. Content from an application residing at the application layer is loaded into the data load field of a TCP segment residing at the transport layer. This TCP segment also contains port information for a remote recipient application module. This TCP segment is loaded into the data field of an IP or UDP datagram residing at the network layer. Next, this IP datagram is loaded into a frame residing at the data link layer. This frame is then encoded at the physical layer and the content transmitted over a network such as an Internet, Local Area Network (LAN) or Wide Area Network (WAN). The term Internet refers to a network of networks. Such networks may use a variety of protocols for exchange of information, such as TCP/IP, ATM, SNA, SDI, etc, and may be used within a variety of topologies or structures. This network may include a Carrier Sensing Multiple Access Network (CSMA) such an Ethernet based network. This network may include a Code Divisional Multiple Access (CDMA) network or some other suitable network.

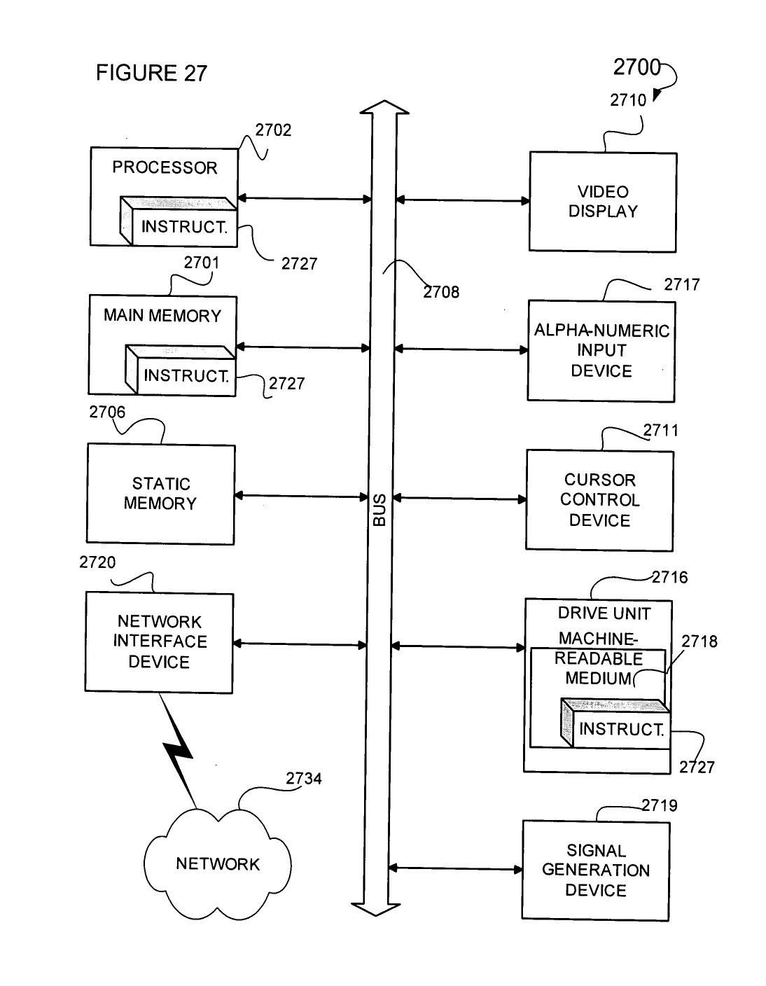

FIG. 27 shows a diagrammatic representation of a machine in the example form of a computer system 2700 which executes a set of instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment or as a peer machine in a peer-to-peer (or distributed) network environment. The machine may be a Personal Computer (PC), a tablet PC, a Set-Top Box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network both perform tasks such as those illustrated in the above description.

The example computer system 2700 includes a processor 2702 (e.g., a Central Processing Unit (CPU), a Graphics Processing Unit (GPU) or both), a main memory 2701 and a static memory 2706, which communicate with each other via a bus 2708. The computer system 2700 may further include a video display unit 2710 (e.g., a Liquid Crystal Display (LCD) or a Cathode Ray Tube (CRT)). The computer system 2700 also includes an alphanumeric input device 2717 (e.g., a keyboard), a User Interface (UI) cursor controller 2711 (e.g., a mouse), a disk drive unit 2716, a signal generation device 2719 (e.g., a speaker) and a network interface device (e.g., a transmitter) 2720.

The disk drive unit 2716 includes a machine-readable medium 2718 on which is stored one or more sets of instructions and data structures (e.g., software) embodying or utilized by any one or more of the methodologies or functions illustrated herein. The software may also reside, completely or at least partially, within the main memory 2701 and/or within the processor 2702 during execution thereof by the computer system 2700, the main memory 2701 and the processor 2702 also constituting machine-readable media.

The instructions 2727 may further be transmitted or received over a network 2734 via the network interface device 2720 utilizing any one of a number of well-known transfer protocols (e.g., HTTP, Session Initiation Protocol (SIP)).

The term “machine-readable medium” should be taken to include a single medium or multiple mediums (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

### Marketplace Applications

Some embodiments utilized in the marketplace may include a method that includes receiving a search query containing a selected advertising keyword, retrieving a search result using the search query, the search result corresponding with the selected advertising keyword, and sorting the search result using the selected advertising keyword, giving priority to the selected advertising keyword using a monetizing of the selected advertising keyword. Further, this method may include selected advertising keyword is contained in an advertisement. Further, the advertisement may be transmitted across a network, the network including at least one of a radio network, a television network, a cable network, or an internet network. Moreover, the monetizing includes associating a monetary value with the selected advertising keyword, the monetary value including at least one of a discount value, a premium value, an auction value, or a market value. Additionally, the method may include setting the auction value on the basis of competing bids between advertisers relating to the selected advertising keyword. The method may further include receiving the search query, and determining a first geographical location relating to a party generating the search query, receiving the selected advertising keyword, and determining a second geographical location relating to an advertiser, obtaining the search result in response to the search query based, at least in part, upon the correspondence between the geographical location of the party generating the search query and the advertiser, and sorting the search result using the monetizing of the selected advertising keyword. Additionally, the first and second geographical locations are determined by analyzing an IP address. Moreover, the method may include sorting using at least one criteria, wherein the criteria includes at least one of highest ROI, search result with the highest airplay on the network, and advertisements played by broadcast stations with the highest industry ratings. This highest industry ratings may include at least one of Arbitron ratings and Nielsen ratings.

Example embodiments used in the marketplace may include a method including sorting a group of broadcast advertisement search results using a broadcast metric, the broadcast metric providing a basis to place a member of the group of broadcast advertisement search results in a higher position relative to at least one other member of the group of broadcast advertisement search results, and transmitting the group of broadcast advertisement search results as a sorted group. Further, the group of broadcast advertisement search results may include at least one of a radio broadcast advertisement, television broadcast advertisement, or internet broadcast advertisement. Additionally, the broadcast metric may include at least one of ad revenue generated by a broadcast advertisement during a specific time frame, an ad budget spent on the broadcast advertisement during a specific time frame, or a number of impressions during a specific time frame, where the number of impressions are a function of the number of people who have been presented the broadcast advertisement. Moreover, the broadcast metric may include at least one of an estimated number of listeners in a listening timeframe, an estimated number of viewers in a viewing timeframe, or an estimated number of online users accessing a content in an online availability timeframe. Additionally, the listening timeframe may be hourly, daily, or weekly. Still further, the listening timeframe may include at least one of a morning time slot, an evening time slot, a rush-hour time slot, or a prime-time time slot, wherein the viewing timeframe is hourly, daily, or weekly. In some cases, the viewing time frame includes at least one of a prime-time time slot, a day-time time slot, or an after-hours time slot. The method may also include sorting the group of broadcast advertisement search results is a function of the broadcast metric and a placement fee, wherein the placement fee is used to place the member of the group of broadcast advertisement search results in a higher position relative to at least one other member of the group of broadcast advertisement search results. Additionally, the method may include discounting a price of the paid placement, the discounting based upon a number of paid placements purchased. The method may also include comprising attaching a premium to a price of the paid placement, the premium based upon a number of paid placements relating to a particular advertising space. In some cases, the method may include receiving a search query, the search query including a term relating to a broadcast advertisement, using the search query to search a data store, and obtaining the group of broadcast advertisement search results. The broadcast metric may provide a basis to place a member of the group of broadcast advertisement search results in a lower position relative to other members of the search results.

It is to be understood that the above description is intended to be illustrative and not restrictive. Although numerous characteristics and advantages of various embodiments as illustrated herein have been set forth in the foregoing description, together with details of the structure and function of various embodiments, many other embodiments and changes to details may be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels and are not intended to impose numerical requirements on their objects.

The Abstract of the Disclosure is provided to comply with 37 C.F.R. § 1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a selected advertising keyword, wherein the selected advertising keyword is associated with an advertisement transmitted across a network;
monetizing the selected advertising keyword; and
storing the selected advertising keyword in a database.

2. The method of claim 1, wherein the monetizing is based upon at least one of a selected keyword activity, or a selected keyword ranking.

3. The method of claim 1, wherein the network includes at least one of a radio network, a television network, a cable network, or an internet network.

4. The method of claim 1, further comprising:
receiving a search query containing the selected advertising keyword; and
sorting the selected advertising keyword based upon its relationship to other selected advertising keywords, giving priority to certain selected advertising keywords based upon the monetizing of the certain selected advertising keywords.

5. The method of claim 4, further comprising giving priority to the certain selected advertising keywords based upon a payment made by an advertiser.

6. The method of claim 1, further comprising:
receiving a search query, and determining a first geographical location relating to a party generating the search query;
receiving the selected advertising keyword, and determining a second geographical location relating to an advertiser;
obtaining a search result in response to the search query based, in part, upon the similarity between the first geographical location and the second geographical location;
sorting the search result based upon the monetizing of the selected advertising keywords; and
transmitting the search result to the party generating the search query.

7. The method of claim 6, wherein first geographical location and the second geographical location is determined by analyzing an Internet Protocol (IP) address.

8. The method of claim 6, further comprising sorting based upon at least one criteria, wherein the criteria includes at least one of a highest Return On Investment (ROI), search results with the highest airplay on the network, or advertisements played by broadcast stations with the highest industry ratings.

9. The method of claim 8, wherein the highest industry ratings include at least one of Arbitron ratings, and Nielsen ratings.

10. A computer system comprising:
a first receiver to receive a selected advertising keyword, wherein the selected advertising keyword is associated with an advertisement transmitted across a network;
a monetizing engine to monetize the selected advertising keyword; and
a data store to store the selected advertising keyword in a database.

11. The computer system of claim 10, wherein the monetizing is based upon at least one of a selected keyword activity, or a selected keyword ranking.

12. The computer system of claim 10, wherein the network includes at least one of a radio network, a television network, a cable network, or an internet network.

13. The computer system of claim 10, further comprising:
a second receiver to receive a search query containing the selected advertising keyword; and
a first sorting engine to sort the selected advertising keyword based upon its relationship to other selected advertising keywords, giving priority to certain selected advertising keywords based upon the monetizing of the certain selected advertising keywords.

14. The computer system of claim 13, further comprising a priority engine to give priority to the certain selected advertising keywords based upon a payment made by an advertiser.

15. The computer system of claim 10, further comprising:
a second receiver to receive a search query, and determining a first geographical location relating to a party generating the search query;
a third receiver to receive the selected advertising keyword, and determining a second geographical location relating to an advertiser;
a retriever to obtain a search result in response to the search query based, in part, upon the similarity between the first geographical location and the second geographical location;
a first sorting engine to sort the search result based upon the monetizing of the selected advertising keywords; and
a transmitter to transmit the search result to the party generating the search query.

16. The computer system of claim 15, wherein first geographical location and the second geographical location is determined by analyzing an Internet Protocol (IP) address.

17. The computer system of claim 15, further comprising a second sorting engine to sort based upon at least one criteria, wherein the criteria includes at least one of a highest Return On Investment (ROI), search results with the highest airplay on the network, or advertisements played by broadcast stations with the highest industry ratings.

18. The computer system of claim 17, wherein the highest industry ratings include at least one of Arbitron ratings, and Nielsen ratings.

19. An apparatus comprising:
means for receiving a selected advertising keyword, wherein the selected advertising keyword is associated with an advertisement transmitted across a network;
means for monetizing the selected advertising keyword; and
means for storing the selected advertising keyword in a database.

20. A machine-readable medium comprising instructions, which when implemented by one or more machines, that cause the one or more machines to perform the following operations:
receiving a selected advertising keyword, wherein the selected advertising keyword is associated with an advertisement transmitted across a network;
monetizing the selected advertising keyword; and
storing the selected advertising keyword in a database.
